(19) United States
(12) Patent Application Publication
(10) Pub. No.: US 2014/0250163 A1
(43) Pub. Date: Sep. 4, 2014

(54) DOCUMENT DELIVERY WITH MULTIPLE ADDRESSING AND DELIVERY OPTIONS

(71) Applicant: DWCD Direct LLC, Camarillo, CA (US)

(72) Inventors: Stephen Schneider, Covina, CA (US); Christopher Floyd, Camarillo, CA (US); David DePaolo, Camarillo, CA (US)

(21) Appl. No.: 14/275,627

(22) Filed: May 12, 2014

Related U.S. Application Data
(63) Continuation-in-part of application No. 14/085,625, filed on Nov. 20, 2013.
Application No. 14/085,625 is a continuation-in-part of application No. 13/561,609, filed on Jul. 30, 2012, now Pat. No. 8,600,904.

(51) Int. Cl. H04L 12/58; G06Q 10/08

(52) U.S. Cl. CPC H04L 51/34; G06Q 10/0838
USPC 709/202

(57) ABSTRACT

A computer program product and method for delivery of electronic and physical documents, with multiple addressing and delivery options. The system may receive uploaded electronic documents and deliver the documents electronically based on only a substantially correct physical address, or based on only a username. The recipient may choose the method of delivery of the uploaded documents. A tag may be input in order to associate the received electronic documents with others having the same tag. Optional services include, but are not limited to, e-signatures, certified mail, electronic and physical proofs of service, and email confirmation.

### CROSS-REFERENCE TO RELATED APPLICATIONS

The present application is a continuation-in-part of application Ser. No. 14/085,625, filed on or about Nov. 20, 2013 entitled “Document Delivery System with E-Mail Uploader for Automatic Storage of Documents in a User Account,” which is a continuation-in-part of nonprovisional application Ser. No. 13/561,609, filed on or about Jul. 30, 3012 entitled “Document Delivery System with Proof of Service,” naming the same inventors as in the present application. These applications are incorporated herein by reference the same as if fully set forth.

### BACKGROUND OF THE INVENTION

1. Field of Invention

The present disclosure relates to document delivery systems and, more particularly, to a delivery system for electronic or paper documents with multiple addressing and multiple delivery options.

2. Description of Related Art

Delivery of physical documents has been an important part of daily life for quite some time. At one point, the United States Postal Service and commercial carriers, e.g., Federal Express™, and/or personal couriers, were the main avenues for the delivery of physical documents. With the rise of computers, electronic documents are being delivered with increasing frequency.

Under certain circumstances, it may be crucial or significant for the sender to verify that the documents have been sent to the intended recipient. In fact, in some cases, e.g., where legal and financial documents are involved, it may be required that the sender establish service to a recipient of the contents of transmitted documents. Businesses may exchange millions of electronic documents for which proof of service may be useful or required.

Recipients may wish to choose the method by which documents are delivered to them. Some recipients may choose to receive documents electronically, as opposed to in paper form, particularly those recipients who subscribe to the concept of a paperless office. Where individuals or business entities have such preferences, senders may not be aware of such preferences. Moreover, the sender may not have the information needed to carry out the intended recipient's preferred delivery method. For example, the sender may only have a physical address for the intended recipient, and the recipient prefers to receive documents electronically.

Accordingly, there is a need for a hybrid document delivery system that provides for electronic delivery where the recipient only knows a physical address. There is further a need for a document delivery system that permits individuals and businesses to verify information related to delivered documents, such as when the documents were sent, when they were received, and the general contents of delivered documents. Those involved with document delivery may wish to look back and review documents with a particular subject or topic. Accordingly, there is also a need for a document delivery system that incorporates the features noted above, but that also permits searching for documents associated with a particular subject or topic.

### BRIEF SUMMARY OF DISCLOSURE

The present disclosure addresses the needs noted above by providing a delivery system for electronic and paper documents with multiple addressing and delivery options. In accordance with one embodiment of the present disclosure, a non-transitory computer-readable medium for document delivery to an electronic endpoint is provided. The computer readable medium embodies a set of instructions which, when executed by one or more computer processors, comprises a document receipt code segment configured to receive electronic documents for delivery to one or more electronic endpoints. The document receipt code segment is also configured to receive recipient data with each said received electronic document, said recipient data including at least one physical delivery endpoint or at least one username. The document receipt code segment further includes a tag input code segment, said tag input code segment being configured to receive input of one or more tags associated with at least one received electronic document. The set of instructions further comprises an addressing code segment configured to retrieve, based on recipient data, an electronic endpoint associated with the recipient data that includes only the physical delivery endpoint, or based on recipient data that includes only the username.

The set of instructions also comprises a mail delivery code segment configured to deliver the received electronic document to an electronic endpoint based on recipient data that includes only the physical endpoint, said mail delivery code segment being further configured to deliver the received electronic document to an electronic endpoint based on recipient data that includes only the username. The set of instructions still further comprises a formatting code segment configured to format each physical delivery endpoint according to a formatting standard, the formatting code segment being further configured to substantially match address components for the received physical delivery endpoint to known address components.

The set of instructions also comprises a proof of service code segment configured to provide proof of service of each served electronic document if a proof of service request has been received; and a receipt record code segment configured to generate and deliver a receipt record to a shipper, wherein the receipt record includes delivery data for the electronic document, including the time an electronic document was delivered to an electronic endpoint.

In accordance with another embodiment of the present disclosure, another non-transitory computer-readable medium is provided. This medium is for delivering documents to electronic and/or physical endpoints with multiple addressing and delivery options. The computer-readable medium embodies a set of instructions which, when executed by one or more computer processors, comprises a document receipt code segment configured to receive electronic documents for delivery to one or more physical and/or electronic endpoints, wherein the document receipt code segment is also configured to receive recipient data with each said received electronic document, said recipient data including at least one physical delivery endpoint or at least one username.

The document receipt code segment further includes a tag input code segment, said tag input code segment being configured to receive input of one or more tags associated with at least one received electronic document, said tag input code segment being further configured to associate the tagged, received electronic document with other received electronic documents that were sent to or from a querying user, if any, having the same tag.

The set of instructions further comprises an addressing code segment configured to retrieve, based on recipient data, at least one electronic and/or physical endpoint associated with the recipient data; and a mail delivery code segment configured to determine whether a received electronic document is to be delivered to a recipient via physical or electronic endpoint based on recipient data, the mail delivery code segment being further configured to deliver the received electronic document to an electronic endpoint based on recipient data that includes either only a physical endpoint or only a username.

The set of instructions still further comprises a formatting code segment configured to format each received physical endpoint according to a formatting standard that permits aggregation of received electronic documents from multiple senders to a physical endpoint composed of known address components that substantially match address components for the received physical endpoint.

The set of instructions also comprises an aggregation code segment configured to facilitate the aggregation of physical documents into a single multi-document package from the multiple senders for delivery to the one or more endpoints, if the determined endpoint is physical, and wherein the aggregation code segment is further configured, based on unbundled delivery requirements associated with a particular endpoint of the one or more physical endpoints, not to aggregate physical documents for delivery in a package to the particular endpoint.

The set of instructions also comprises a proof of service code segment configured to provide proof of service of each served physical and/or electronic document if a proof of service request has been received; and a multi-document validation code segment configured to validate, based on either a unique identification code for each received electronic document or a unique package identification number for a single multi-document package, that a multi-document package addressed to a physical endpoint includes all received electronic documents for a recipient at the physical endpoint.

The set of instructions also comprises a receipt record code segment configured to generate and deliver a receipt record to a shipper, wherein the receipt record includes delivery data for the physical and/or electronic document, including the time an electronic document was delivered to an electronic endpoint.

In accordance with yet another embodiment of the present disclosure, a computer-based method is provided for delivering physical and electronic documents with multiple addressing and delivery options. The method comprises receiving, by a computer, a plurality of electronic documents, for delivery to one or more physical and/or electronic endpoints, wherein at least one of the plurality of received electronic documents includes recipient data indicating delivery to a physical endpoint, and at least one of the plurality of electronic documents includes recipient data indicating delivery to an electronic endpoint, said recipient data including at least one physical delivery endpoint or at least one username.

The method also comprises receiving, by the computer, one or more tags associated with at least one received electronic document; and retrieving, by the computer, based on recipient data, an electronic endpoint associated with the recipient data that includes only the physical delivery endpoint, or based on recipient data that includes only the username.

The method still further comprises determining, by the computer, whether a received electronic document is to be delivered to a recipient via physical or electronic endpoint based on recipient data.

In response to the determining step, the method comprises performing the following steps for each of the plurality of electronic documents: (a) if the determining step indicates delivery to an electronic endpoint, delivering, by the computer, the received electronic documents to electronic endpoints based on recipient data that includes only the physical endpoint; (b) if the determining step indicates delivery to an electronic endpoint, delivering, by the computer, one or more received electronic documents to electronic endpoints based on recipient data that includes only a username; (c) if a request for proof of service has been received, providing, by the computer, proof of service of each served physical and/or electronic document; and (d) generating, by the computer, and delivering, by the computer, an electronic receipt record to a shipper, wherein the receipt record includes delivery data for the served physical and/or electronic document, including the time the electronic document was delivered to the electronic endpoint and/or the time the physical document was released to a carrier for physical delivery.

These, as well as other objects, features and benefits will now become clear from a review of the following detailed description of illustrative embodiments and the accompanying drawings.

### BRIEF DESCRIPTION OF DRAWINGS

FIG. 1 is a flow chart for the document delivery system with proof of service in accordance with one embodiment of the present disclosure.

FIG. 2 is a screenshot that user account activation screenshot for the document delivery system in accordance with one embodiment of the present disclosure.

FIG. 3 is a user registration screenshot indicating that the user has registered to have all documents delivered by electronic mail, as opposed to paper mail, in accordance with one embodiment of the present disclosure.

FIG. 4 is an electronic mail interface that a user may use to upload the documents into the document delivery system in accordance with one embodiment of the present disclosure.

FIG. 5 is a screenshot of a user's device as the user creates an email for uploading documents into the document delivery system of the present disclosure.

FIG. 6 is a screenshot that illustrates a user's account settings in accordance with one embodiment of the present disclosure.

FIG. 7 is a user screenshot that results after a user has successfully and automatically inserted an email attachment into a list of files in a mailing package in accordance with one embodiment of the disclosure.

FIG. 8 is a screenshot illustration of the initial screen shown when a sender submits a document into the document delivery system in accordance with one embodiment of the present disclosure.

FIG. 9 is a screenshot illustration showing an upload of a document into the document delivery system in accordance with one embodiment of the present disclosure.

FIG. 10 is a screenshot that permits a user to enter additional documents into a package for the document delivery system in accordance with one embodiment of the present disclosure.

FIG. 11 is a screenshot that permits a user to enter information for the package to be delivered in accordance with one embodiment of the present disclosure.

FIG. 12A is a screenshot of a user address validation box used to validate recipient addresses so that documents may be delivered in accordance with one embodiment of the present disclosure.

FIG. 12B is a screenshot of a valid address list showing recipient delivery addresses have been validated in accordance with one embodiment of the present disclosure.

FIG. 13 is a screenshot of a user outbox as the user prepares to send documents for delivery over the document delivery system in accordance with one embodiment of the present disclosure.

FIG. 14 is a screenshot that permits a user to enter a recipient for the package and submit the package for delivery in accordance with one embodiment of the present disclosure.

FIG. 15 is a screenshot that permits a user to select optional services for a package to be delivered by the document delivery system in accordance with one embodiment of the present disclosure.

FIG. 16 is a screenshot at a recipient's computer after the recipient has opened the package subject to proof of service in accordance with one embodiment of the present disclosure.

FIG. 17 is a screenshot of a user inbox for the document delivery system in accordance with one embodiment of the present disclosure.

FIG. 18 is a proof of service generated by the system in accordance with one embodiment of the disclosure.

FIG. 19 is a screenshot of e-signatures pertaining to documents delivered over the document delivery system in accordance with one embodiment of the present disclosure.

FIG. 20 is a screenshot of a sender's receipt record for the package subject to proof of service in accordance with one embodiment of the present disclosure.

### DETAILED DESCRIPTION OF THE DISCLOSURE

The document delivery computer program product and method of the present disclosure permits the receipt of uploaded electronic documents, including receipt of such documents via an email attachment when the email is addressed to an assigned system email address. Each system recipient may choose the method of delivery for the uploaded electronic documents. The sender need not know what form of delivery the recipient has chosen. The sender only needs one piece of information to identify the recipient, e.g., a close approximation of the recipient's physical street address or an @address that uniquely identifies the recipient/user.

The received electronic documents that have been uploaded to the document delivery system may be delivered in either physical or electronic form to one or more recipients or endpoints. The endpoints may be physical or electronic. A physical endpoint may be a street address, post office box or other physical location. An electronic endpoint may be an inbox associated with the intended recipient, and the inbox may be provided by the document delivery system. The upload may be accomplished by a sender/shipper, who may request that the documents be delivered to specified recipients or an alias associated with an endpoint. The alias may be, for example, a company name or an @address username that the user may choose based on availability. The document delivery system and/or its various subsystems described herein include one or more nontransitory computer readable-media. These media, in turn, comprise instructions that may be executed by one or more processors.

The document delivery system of the present disclosure may provide proof of service of both physical and electronic documents. These documents may include writings, photographs, images, graphs and charts. The documents may also include sound recordings, and other data or data compilations, e.g., computer programs or any other information. It should be noted that certain documents may originate in physical form and may be scanned and received or uploaded as electronic documents by the document delivery system.

After the electronic documents have been received by the document delivery system, the system's mail delivery subsystem may determine whether the received electronic documents should be delivered electronically or physically, depending on the delivery method chosen by the intended recipient. As used herein, documents uploaded and received by the document delivery system—but not yet served or delivered as physical and/or electronic documents—are referred to as received electronic documents. Where the intended recipient has chosen digital delivery to an electronic endpoint, the document may be delivered electronically to the system. The document may be opened thereafter by the intended recipient when the intended recipient logs onto his/her account. Where no delivery method has been designated, physical delivery to a physical endpoint may be the default option.

A proof of service may be generated once the delivery method has been determined. The proof of service may document the method of delivery of a particular document, an aggregated group of documents or other grouping of documents. As used herein, the terms “served electronic document” and “served physical document” refer to received electronic documents that have been served, but not necessarily delivered yet. However, a received electronic document that is to be served to an electronic endpoint may be considered served and delivered when it is delivered to the recipient's inbox. A received electronic document that is to be served to a physical endpoint may be considered served when it is placed into a physical mail stream and/or transferred or released to a physical carrier for delivery.

The proof of service may be digitally or electronically signed by a person associated with the system who certifies the manner in which proof of service is carried out. This part of the proof of service process is the same regardless of whether the documents are delivered electronically or physically. If the documents are to be electronically delivered, a copy of each document may be electronically delivered to the intended recipient via an inbox associated with the system or other electronic means. The proof of service may be attached to the document, if the document is electronically delivered.

If the documents are to be physically delivered, a document constituting the proof of service may become a part of the physical document package to be delivered. In this case, the documents may be physically released or transferred to a commercial carrier e.g., the United States Postal Service or FEDEX™, so that it may ultimately be delivered to the intended recipient at a physical endpoint. In this case, the document delivery system may rely on the third party carrier to effect delivery of the physical document. The proof of service may be inserted into the document as the last page.

Where the received electronic documents are to be delivered as physical documents, the document delivery system of the present disclosure may aggregate the documents into a single package at an efficient price point. The document delivery system may intelligently decide whether to aggregate the document along with other documents into a multi-document package and provide for delivery either by commercial carrier or other physical delivery method. As used herein, the term “delivered physical document” refers to a physical document that has been physically delivered to the physical endpoint for an intended recipient. The term “delivered electronic document” refers to an electronic document that has been electronically delivered to an electronic endpoint.

Optional services available to the sender may include, but are not limited to, certified mail, proof of service, email confirmation, e-signatures, e-certification and electronic tracking of the delivery documents. As for the certified mail option, the sender would choose this option if the sender wanted a certified receipt confirming physical delivery, not just a confirmation of mailing. Senders who select this option may receive a scanned image of a declaration of actual physical delivery. and signature by the end point recipient. In the case of physical delivery, this image could be in the form of a signed United States Postal Service certified mail card, or an image of a declaration of personal physical service on the endpoint recipient by a person (such as from a courier service). In the case of electronic delivery, this image could also take the form of a signed declaration of an employee associated with the document delivery system. This declaration may confirm that the piece was delivered electronically within the network and was actually opened by the endpoint recipient.

As for the email confirmation option, the sender would choose this option if the sender wanted an email confirmation of the mailing of a document—not a confirmation that it was received or read. The system would send the sender an email when the document was mailed or delivered electronically. This email would not be a signed or confirmed receipt that the endpoint recipient read the document.

The sender may also choose to obtain an e-signature on the document, whereby the recipient would e-sign the document that the recipient received. The e-signature may essentially represent that the recipient who signed did, indeed, personally receive the subject electronic document. The identity of the e-signer as well as the date and time the document delivery was signed, may also be a part of information associated with the e-signature.

An e-certification may also be provided by the document delivery system. The e-certification may be electronically generated, and may essentially represent details regarding the document delivery, including but not limited to, one or more of a unique identification code associated with the document or group of documents, the date and time the document was sent, the date and time was delivered, and the time it was opened, whether an e-signature was received for the document, the number of pages and file size of the document, whether a proof of service was generated for the document, whether the document was copied to another storage location as well as the type or name of the storage location, and any other details related to the document delivery.

After the package has been delivered, the sender may receive a receipt that includes an audit log. Where the documents have been delivered electronically via the document delivery system, the audit log may show when the document was received at the recipient's electronic endpoint or, for delivery to physical endpoints, when the document was released or transferred to a carrier.

After document delivery to electronic endpoints, the system may thereafter track electronic actions taken in connection with the document/package. For example, the system may track when the document was opened, and/or when the document was printed and/or forwarded. A bar code or other unique identifier associated with the document may facilitate its tracking. The audit log may also show when the intended recipient logged on to the system since the system is a web-based application programming interface (API). If a document was opened, the system may track how long it was opened. The system knows if the intended recipient saw the title for the transmitted document in their inbox. As long as the document is in the data server for the document delivery system, it can be tracked. The system may also include encryption or other data protection measures in order to prevent unauthorized access.

In some circumstances, a document may be delivered electronically by the document delivery system, but may remain unopened for a long period of time. In this case, the sender/shipper may elect to have the system recall the unopened document from the electronic delivery endpoint and change the delivery method to paper. Then, the system would re-send the previously delivered document as a paper document to a physical delivery endpoint. The document delivery system of the present disclosure may be useful for a number of persons and entities, and may also be useful for businesses that regularly send documents back and forth to each other. Each document designated for delivery may have a unique identification number. Using'that unique identification number, the document may be tracked from the time it is received by the system until it is delivered to an endpoint or recipient. A unique identifier may also be associated with a group of documents, such as documents that have been aggregated.

This document delivery system may be implemented as a web-based system. The system may be accessible via the Internet by subscribers who provide the proper authentication credentials.

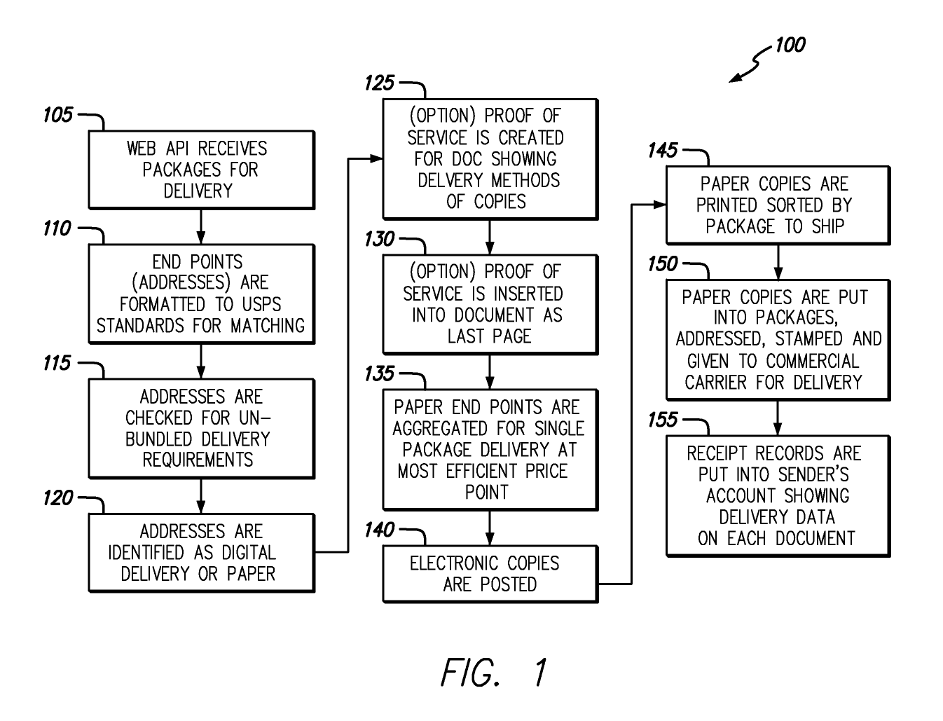

Referring now to FIG. 1, illustrated is a flow chart for the document delivery system in accordance with one embodiment of the present disclosure. Flow chart 100 includes steps that may be taken by the document delivery system from the time the packages are received up until the time the packages are delivered. It should be understood that this is one embodiment of the system, and that other steps may be taken and/or some of the illustrated steps may not be taken.

At step 105, the web application programming interface (API) may receive packages to be delivered by the document delivery system. The web API may permit the upload of documents via email, or any other suitable means for receipt. In the examples shown herein, the web interface may need to be in email mode in order to receive the upload of documents via email. In some configurations of the system described herein, the user may be required to upload at least one package via the browser or “my files” mode on the web API before the user is permitted to select the email upload option and receive uploads to his/her account via email. The system may remain in email mode until the user cancels or until user completes submission of his/her order. At step 110, the end points or recipients' addresses may be formatted according to certain standards. For example, the addresses may be formatted so that whenever the word “Boulevard” or “Boulv” or a variant thereof is typed, it appears as “Blvd.” or is corrected to appear as such. This way, there is consistency among the addresses and a match can be readily ascertained. Otherwise, the system may not understand that 103 Washington Boulevard and 103 Washington Blvd. are the same address. An example of a body of addressing standards are those implemented by the United States Postal Service, which can be found at Publication 28, Postal Addressing Standards 7610-03-000-3688, published in April 2010.

Along those same lines, if the user misspells a word in the address, the misspelling of the word can be recognized. For example, the system may be configured to correct “Bulevard”, an obvious misspelling that is substantially similar to the actual correct spelling, so that it reads “Blvd.” The document delivery system may also be able to determine where a street has been misaddressed as an avenue, a route has been misaddressed as a lane, etc.

At step 115, addresses may be checked for unbundled delivery requirements. Here, the package may be flagged where multiple persons/entities occupy the same address. If there are multiple occupants at the same address, then the system may determine that the packages cannot be aggregated as described in more detail in connection with step 135.

At step 120, the addresses may be identified as either a digital delivery address or a paper/physical delivery address. This identification may occur based on the manner in which people at the address have agreed to accept documents—via electronic or physical delivery. Subscribers to the document delivery system may elect to have all documents delivered electronically. For non-subscribers, the default may be set to physical delivery of all documents.

At step 125, optionally, a proof of service may be created for the document showing delivery methods of copies. If the proof of service option is chosen, then at step 130, the proof of service may be inserted as the last page of a document if a physical delivery method is chosen.

At step 135, paper end points may be aggregated. That is, multiple documents addressed to a single address may be aggregated into a single multi-document package. This way, delivery may be accomplished at the most efficient price point. In addition to price point, the scheduled delivery time may also be a determining factor in how the documents are aggregated. Based on the scheduled delivery time, common addresses may be pooled into one package. Collation of the mail to a single endpoint may occur prior to delivery of the documents to a print stream. Where the address is a shared suite with different entities sharing a common address, the system may decide to de-aggregate documents based on the address, and then to re-aggregate them based on name. In this case, documents addressed to a particular recipient may be contained in a single multi-document package. Hard copies of documents coming from the print stream may be delivered physically via common carrier or other suitable carrier.

The system may convert addresses into a standard format, e.g., a standard post office format. The system also may take into account the fact that different users may type in the same address in different ways. The system may convert an address into standard post office address format. For example, no matter how a user spells a street name, the system may recognize the misspelling and suggest a known post office standard address—even if the named recipient is different. The system may also look at the unique address, as standardized by the system, and determine whether the user has an account with an electronic mailbox to which all documents may be delivered. Again, as indicated above, if an address—e.g., a suite—is identified, the system may determine that aggregation or consolidation of the package should not occur with any other address.

The documents in the package may include a cover sheet and, for electronic delivery, the cover sheet may identify the particular person to whom the documents should be delivered. If the documents are delivered physically via common carrier, the documents may have identifying information that is customary for the third-party carrier. The documents and/or package may not necessarily include a cover sheet.

At step 140, electronic copies may be posted to the document delivery system so that they may be retrieved by the intended recipient, if the subscriber/recipient has agreed to accept electronic delivery. The document may be posted in any type of format suitable for the system, including but not limited to a portable document format (PDF), rich text format, word processing format e.g., MICROSOFT™ WORD™, MPEG4, or any other suitable format.

At step 145, paper copies may be printed and sorted by package for shipping. Sorting may occur before the physically-deliverable documents go to print. Sorting may occur manually so that the documents are stuck into package with paper identifiers. At step 150, paper copies may be placed into packages, stamped and given to a commercial carrier for delivery. At step 155, receipt records may be placed into the sender's account showing delivery data for each document. In the case of physical delivery, the shipper's receipt records may be created once the document has been released or transferred to the physical carrier. The document may be considered released or transferred to the physical carrier when, for example, it is placed into a mailbox for pickup, by the United States Postal Service. The document may be considered released or transferred to the physical carrier when, for example, the documents are left in a deposit box under control of the carrier for pick-up by the carrier. In the case of electronic delivery, e.g., if the recipient has agreed to accept electronic delivery, the receipt records may be delivered into the electronic mailbox for the recipient's account.

Described herein are also various computer screenshots that may appear when a user uses the document delivery system to carry out physical and electronic delivery of single-document or multi-document packages. Documents may be uploaded to the system via an email from a user computing device, if the user account is in email mode. Alternatively, documents may be uploaded to the system through a system web interface.

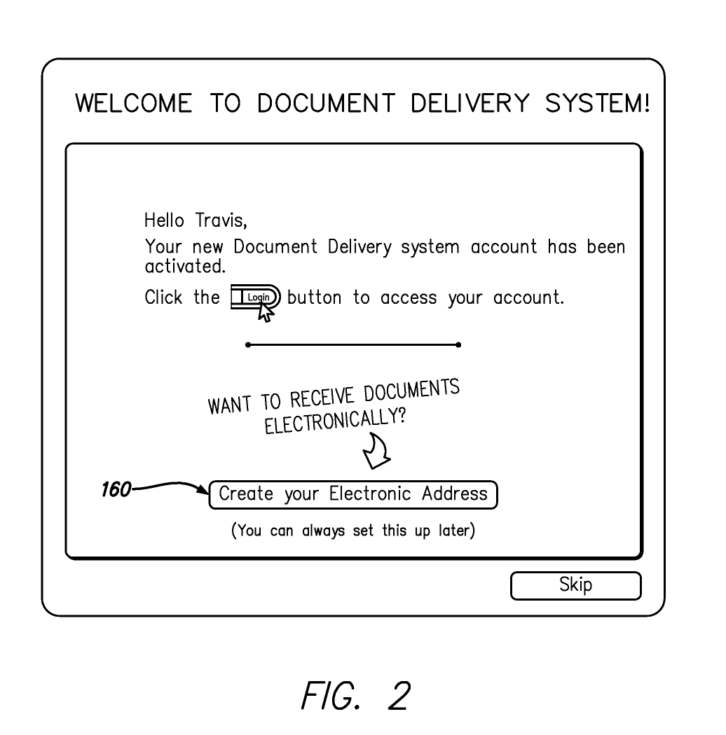

Referring now to FIG. 2, illustrated is a user account activation screenshot for the document delivery system in accordance with one embodiment of the present disclosure. As shown in the user activation screenshot 160, the user has created a new account with the document delivery system. The user is now being given the opportunity to be assigned an @address so that documents may be delivered electronically. The user may elect to receive an @address by selecting the @address creation icon 170.

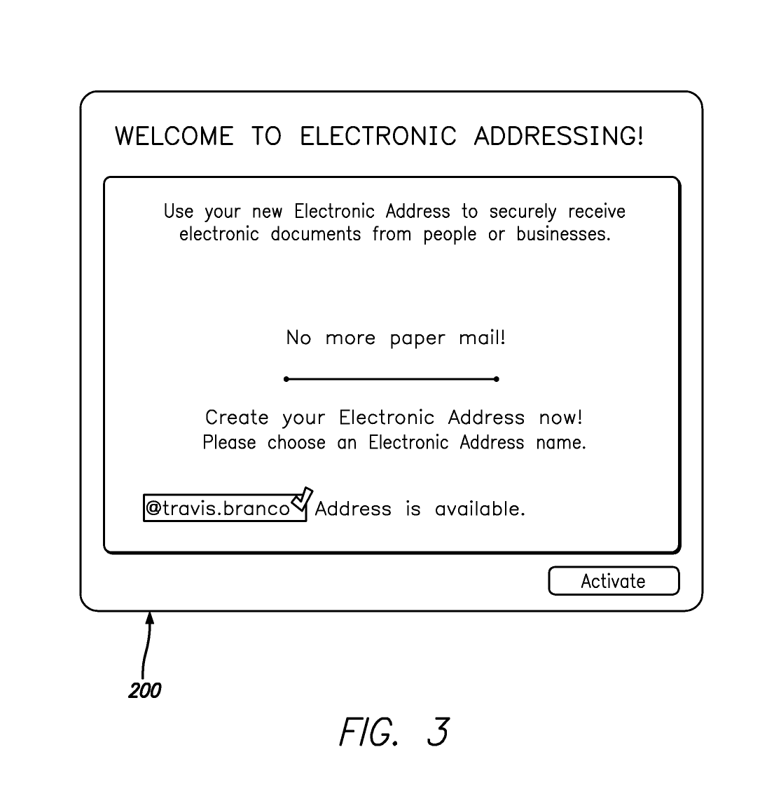

Referring now to FIG. 3, illustrated is a user registration screenshot 200 indicating that the user has registered to have documents delivered electronically, as opposed to physically in the form of paper mail, in accordance with one embodiment of the present disclosure. Now that the user has registered to receive mail by electronic delivery, a sender-user may deliver mail electronically to the recipient-user by electronic delivery, assuming the recipient-user has chosen the electronic delivery option as the preferred form of delivery. In addition, electronic delivery to the @address may occur even where the sender-user does not know the electronic address that is associated with the recipient-user. Where the sender-user inputs a physical address for the recipient-user and the user has elected to received documents via electronic means, the system will cross-reference components of the physical address that were input by the sender-user with a known address. In addition, the system will compare the input name of the recipient-user with known names at the address having known components. Assuming a match occurs, the system will deliver the message electronically. If no match occurs, the sender-user may be notified that no match was found.

The above-referenced addressing and delivery options have a number of benefits. For example, the sender need not know the recipient's @address in order to carry out electronic delivery of documents. On the other hand, the sender may not need to know the recipient's physical delivery address in order to carry out physical delivery of documents. Thus, the recipient may choose the manner of receipt of documents.

In addition, the system may create a repository of all recipients' mail, regardless of the delivery method each recipient has chosen on an individual basis. The repository may be comprised of documents to be delivered to electronic endpoints as well as documents to be delivered to physical endpoints. Such a repository has a number of possibilities for businesses as well as individuals.

The document delivery system of the present disclosure may make it easy for businesses to store, in a single location, the physical and electronic documents it has received from others whom or which the business has notified of its use of the system. For example, a business could notify all of its business associates of its use of the system so that its business associates can send mail through the system. Granted, the recipient business must have an account with the document delivery system in order to receive its documents through the system. The sender-business may also need to have an account.

The document delivery system can also be used as a collaboration tool for employees within a single business. For example, colleagues at different locations of a large business may use the document delivery system to send and receive collaboration documents among each other. The present document delivery system, the sender-user and the receiver-user may use this system, instead of their regular business system in order to track, confirm and have a third party custodian validate information concerning the documents. The sender-user only need to know the recipient-user's @address in order to deliver the document electronically to the recipient-user.

Some business offices that have decided to go the way of the paperless office may have their documents uploaded into the document delivery system and sent electronically using the @address. Also by way of example, colleagues in the same building may use the document delivery system in order to collaborate on a document.

The document delivery system may also be useful among small and large business associates alike for their document delivery needs. An accountant may use the document delivery system to send information to the accountant's clients. The accountant's clients may be able to indicate when they have received and reviewed tax forms, or any other form of legal correspondence. Animal caregivers, such as veterinarians, breeders and SPCA personnel, may find the system useful as well. When animals are transferred from one location to another, or when they are adopted, paper documents may be difficult to obtain as they may become lost over the course of an animal's life span. Using the document delivery system, the records may be maintained by the system as a third party custodian. In this manner, the animal care personnel may share information among each other and confirm that the information was shared. The sharing of such information may be confirmed in a formal manner, suitable for legal transactions. Physicians may use the document delivery system to send information to patients, as well as receive information from patients. For example, a patient may request that his/her medical records be sent over the document delivery system. The physician's office may confirm that the patient has received this information by proof of service or other type of delivery confirmation.

The document delivery system may be capable of delivering sound files. Therefore, recording artists may use the document delivery system to collaborate on musical works. The recording artists may use the system to confirm composing rights, which may be particularly useful in the case of a dispute as to who should be listed. In addition, software developers may use the system to write code. The delivery system may be helpful in establishing rights to credit for software code development, as well as providing a central location for storage of such code.

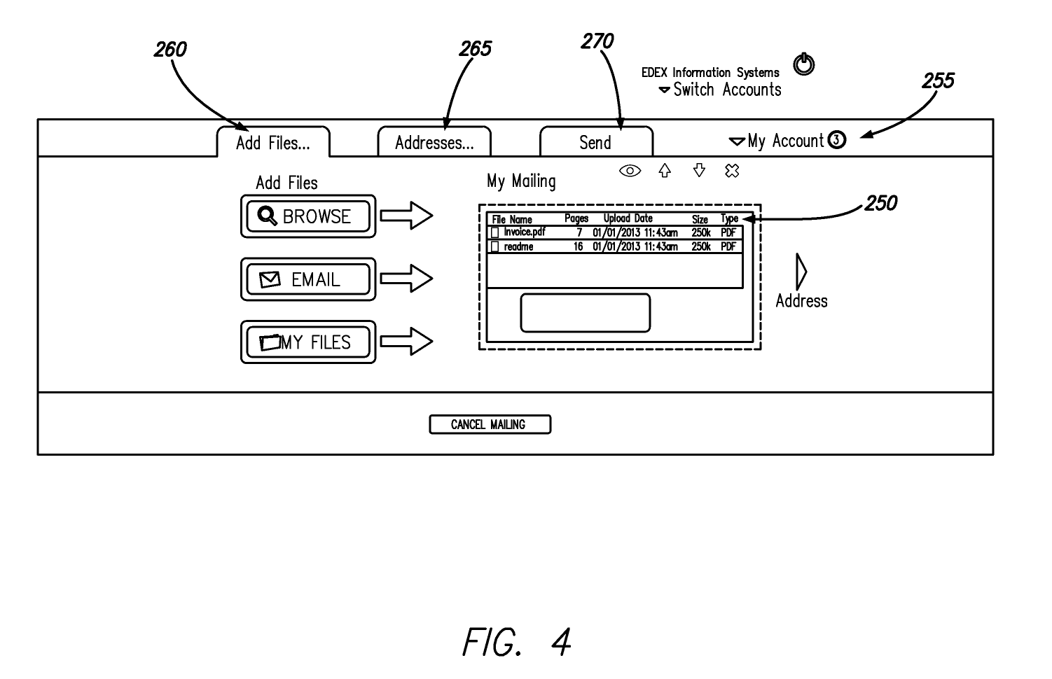

Referring now to FIG. 4, illustrated is a web-based email interface that a user may use to upload the documents into the document delivery system in accordance with one embodiment of the present disclosure. The user has selected the “my account” option as indicated by the “my account” display 255 at the top of the screen. As shown at line 250, the user has already inserted a file titled “invoice.pdf.” The file is three (3) pages, and was uploaded on Jan. 1, 2013 at 14:14. Also shown at line 250 are the file size and the file type. Here, the file size is 908K and the file type is PDF (portable document format). As shown at the top of the screen, three tabs are available for the user to select. The add files tab 260 has been selected by the user. The other options available to the user are the addresses tab 265 and send tab 270.

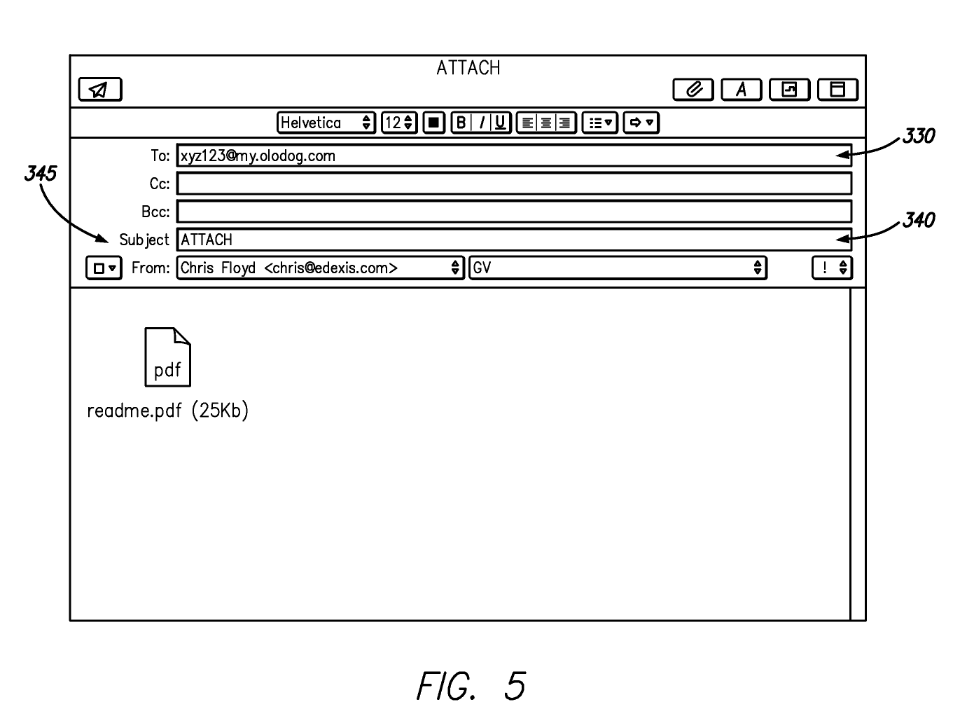

Referring now to FIG. 5, illustrated is a screenshot of a user's device as the user creates an email for uploading documents into the document delivery system of the present disclosure. The document delivery system is capable of receiving documents that the user uploaded via email and that the user has sent to the system via an assigned system email address for the user's account. The user may create the email from his/her computing device, and attach the documents the user desires to have delivered. The user's computing device may be, e.g., a desktop personal computer, a laptop, a tablet e.g., an IPAD™, or any other suitable computing device from which the user is able to send an email with attachments. In the present illustration in FIG. 5, the user is addressing the email to an email address that was assigned to the user by the system. Here, the email is from johndoe@edexis.com as shown at line 345. The user's assigned system email address is shown at line 330 as xvz123@olodog.com. For security purposes, the system may be configured to prohibit users from creating their own system email addresses. The system may be configured to only provide assigned system email addresses by random generation.

The system may also be able to recognize commands typed in the subject line of an email or otherwise. For example, here, the user has entered the word “attach” in the subject of the email at subject line 340. The user has attached one or more files to the email. However, the size of the user attachments may be subject to limitations of the user's email service provider. In this case, the user's service provider may not permit the email to be sent to the system if it exceeds the requisite size. In the present example, the user has attached a file entitled “readme.pdf” to the email. In order to send the email to the system server, the user may press send in the manner he/she would with any other email. If the system were not in mailing mode, the user may be permitted to send a command to enable mail mode. The user may also be able to use his/her system password to encrypt the email attachment in the email file.

The email sent by the user may be received by the document delivery system's server. The document delivery system's server may check the recipient address xyz123@olodog.com and confirm that this email account exists on the document delivery system's server. The server may also cross-reference the xyz123@olodog.com email address to the user account to which the email address belongs. If the system cannot match the email address with an assigned email address, the system may be configured to disregard and/or delete the received email and attachment if it cannot confirm that the email address to which the document was sent is not associated with a user account. The system may also be configured so that it does not communicate with the unconfirmed sender of the disregarded/deleted attachment because of security concerns.

In the present illustration, the server finds that the email address xyz123@olodog.com belongs to John Doe. The server may extract the file attachment(s) from the email message and store the file in the document delivery system. Any email with an attachment that is addressed to an email address having the system domain can be extracted and stored to the system server. It should be noted that the system may be configured to notify only the user of his/her system email address. Other users may be completely unaware of this address, and the system can still accomplish its electronic delivery. The system may then look at the root, e.g., xyz123 and associate the email address to which the email was addressed with a user account on the system. In this example, the server may link the email attachment with user John Doe's account with the document delivery system. On the system side, if a received electronic file has been encrypted, the server may automatically use the user's password to decrypt the file upon receipt. This decryption may occur after a sending user attaches files to a message (e.g., an email), and send the files to the user's assigned system email address. The server may decrypt the attached file(s) as soon as they are extracted from the email and before linking the attachment to a user account.

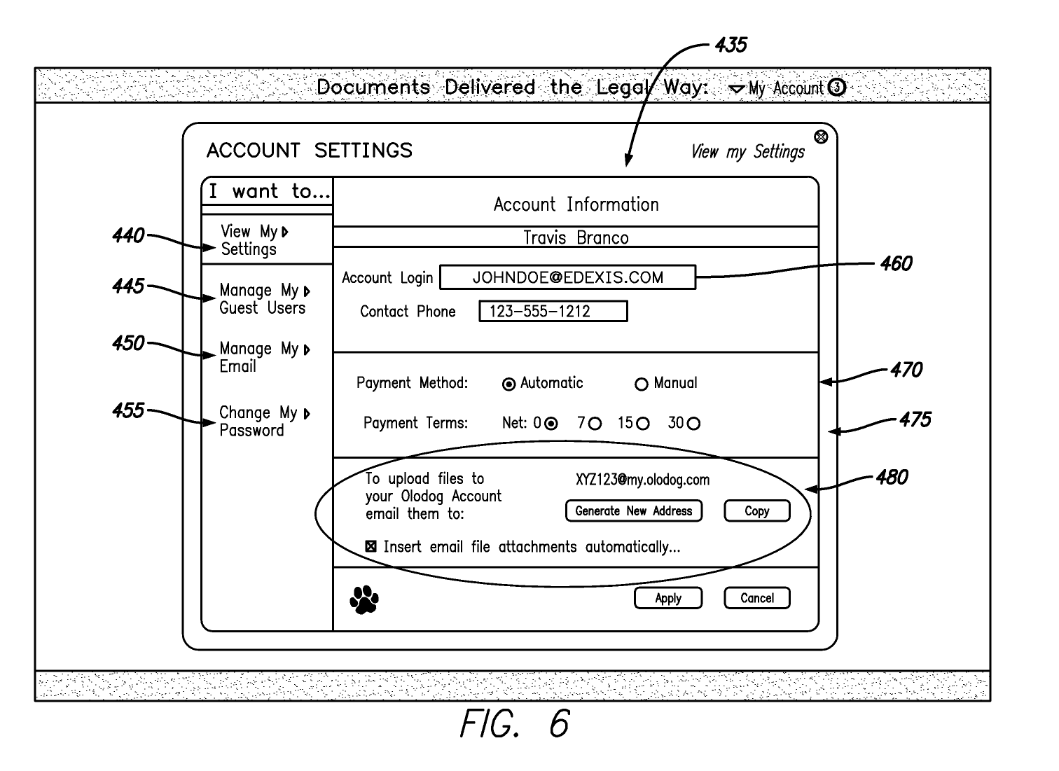

As for the automatic email inclusion feature, in order to determine whether the user has one or more account settings that permit the insertion of emails automatically, the document delivery system's server may check the account setting(s) for the user who was assigned the email address of xyz123@olodog.com. Referring now to FIG. 6, illustrated is a screenshot that shows a user's account settings in accordance with one embodiment of the present disclosure. Here, the user John Doe has chosen a setting that permits the insertion of emails automatically. This automatic email insertion setting is evidenced in the account information area 435 on the right portion of the screen. As shown at line 460, the account being viewed belongs to a user having a non-system email address as johndoe@edexis.com. The system may confirm the automatic email insertion setting via computer readable code. If the user had not had the automatic insertion feature activated, and/or the user had not used the “attach” keyword in the subject line of his email, the system may have stored the file on the server for the user to view and attach manually.

In FIG. 6, an account information area 435 is shown to the right, while a number of user-selectable buttons are shown to the left. Here, the user has selected the view my settings button 440, as indicated by the highlighted button 440 and the notation at the upper right of the screen that reads “view my settings”. Other possible buttons that could have been selected by the user include a manage my guest users button 445, a manage my email button 450, and a change my password button 455. As illustrated at line 470, the payment method may be automatic or manual. Here, the user has selected an automatic payment method. If a user has a credit card on file for the purpose of automatic debits, it may be indicated here. The payment terms may be shown at line 475. Here, the payment terms are 0, meaning the user has 0 days' grace period to pay. The user must pay on the date that the charges are incurred. Otherwise, as shown at line 475, the user would have the option of having his/her account debited or have payment otherwise made in the next 7, 15 or 30 days.

As shown in screenshot area 480, here is the information most pertinent to the setting for automatic email insertion. Here, as shown at the left portion of area 480, there is a notation “To upload files to your Olodog Account, email them to . . . ”. The email address indicated to the right of screenshot area 480 is xyz123@myolodog.com. The user has the option of allowing the system to randomly generate a new assigned email address by selecting the appropriate icon. The user also has the option of copying an email address by selecting the appropriate icon, and pasting the email address into other programs. Importantly, the box is checked for “insert email file attachments automatically.” When this box is checked, the system knows the user has activated automatic email insertion. As shown at the bottom of the account information area 480, the user has the option to apply the current settings or to cancel so that the settings are not applied.

Behind the scenes, the server for the document delivery system has now stored the emailed files in its file system. The server may also link the received attachments to John Doe's account. The system may be configured so that it does not permit the automatic insertion of email attachments unless the user is in the process of creating a new mailing package. Here, John Doe has activated automatic email attachment insertion, and the server has determined that John Doe's user account is building a new mailing package. The system may also include settings that permit the user to select the option of being notified when attachments have been successfully uploaded. The system may notify John Doe via the user's registered non-system email account when the received attachment has been uploaded successfully. The server may now automatically insert the email attachment into the list of files in the mailing package. The server may also update the user's screen to display the new file(s) inserted into the mailing package.

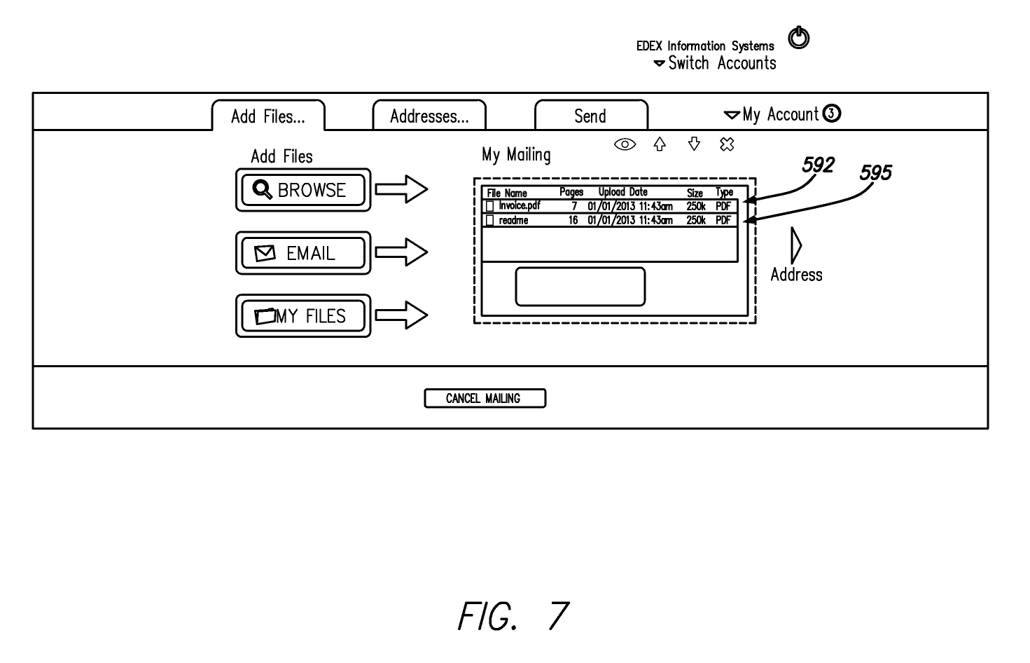

Referring now to FIG. 7, illustrated is a user screenshot that results after a user has successfully inserted an email attachment into a list of files in a mailing package in accordance with one embodiment of the disclosure. As shown in FIG. 7, not only is the original “invoice.pdf” file shown, but also shown at line 595 is the new file titled “readme”. As shown in the next column, the file is 18 pages. The upload date and time are Jan. 1, 2013 at 14:14. The file size (25 KB) and the file type (pdf) may also be shown. The user now sees the updated list of files and may continue the process of adding more files, if desired. The user may complete the addressing and submission of the mailing package in the same manner as other Olodog orders.

In lieu of, or in addition to, an email uploader, the document delivery system may incorporate the ability to upload via short message service (SMS) and multimedia messaging service (MMS). Upload may also be accomplished via a URL-based system, or a system that permits files to be transferred using file transfer protocol (“FTP”), an extension to file transfer protocol known as FTPS, secure file transfer protocol (SFTP), web-based file transfers using hypertext transfer protocol (HTTP) and other suitable file transfer protocols.

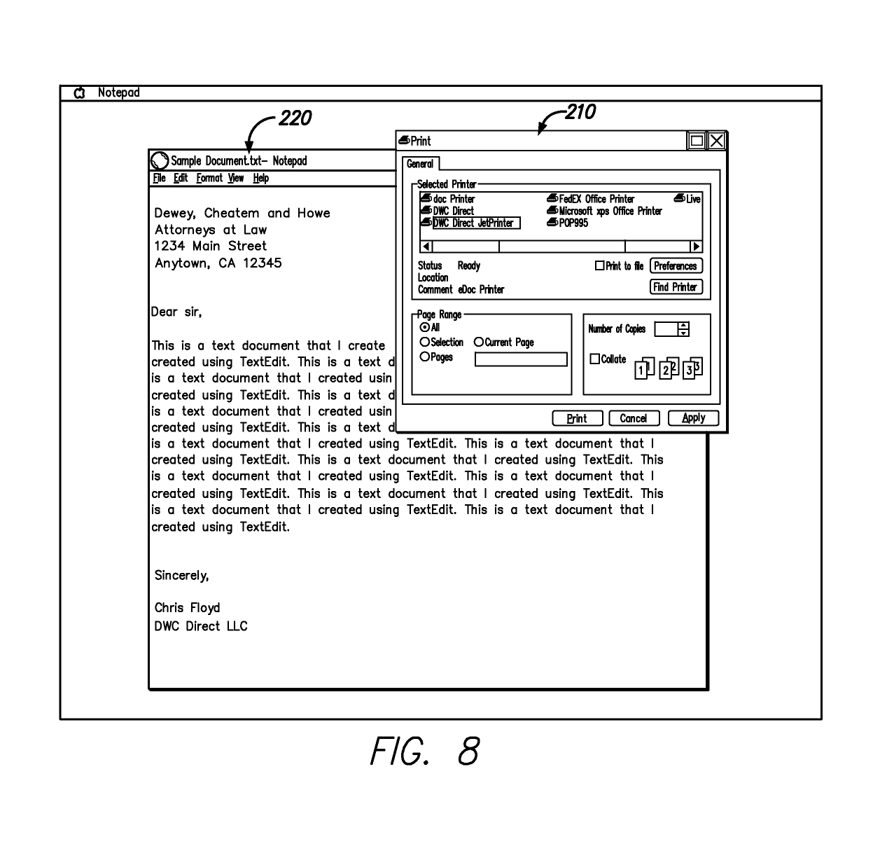

Referring now to FIG. 8, illustrated is the initial screen shown when a user submits a document into the document delivery system via web API (using the browser or “my files” mode) in accordance with one embodiment of the present disclosure. As shown, the screenshot includes an electronic document 220 that the sender wishes to have delivered. The user submits the document into the document delivery system when the user selects the “print” function and designates the specific printer for the document delivery system. Here, the print dialog box 210 shows that the user is making the selection for the document delivery system which is designated here as “DWC Direct JetPrinter.”

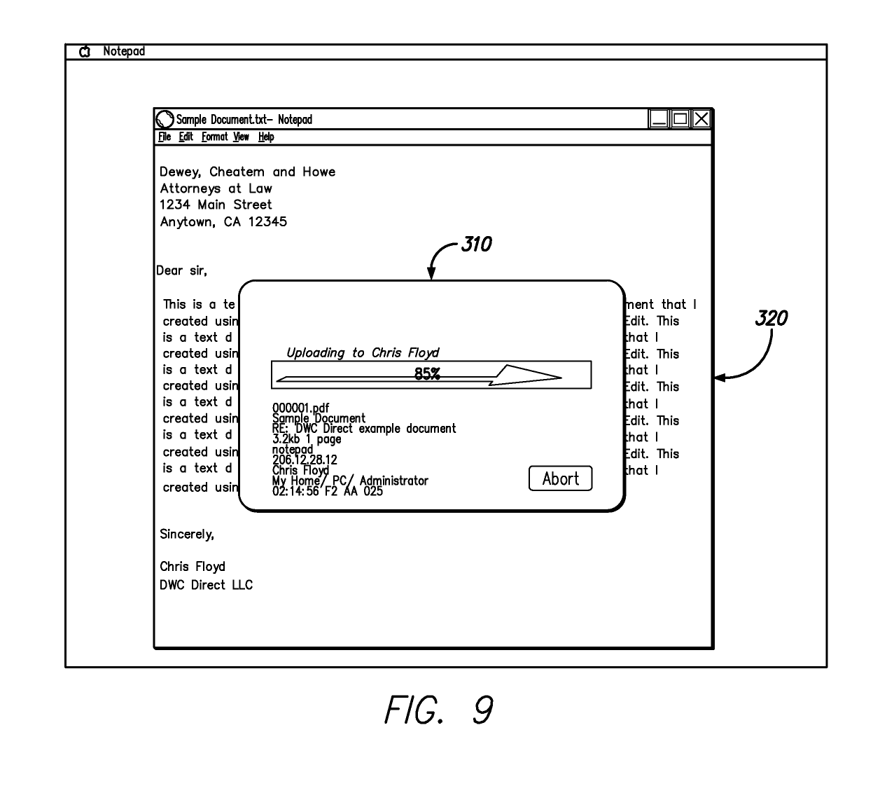

The user may now make sure the document or package (as represented by the electronic file) is uploaded into the system. Referring now to FIG. 9, illustrated is a screenshot showing an upload of a document into the document delivery system in accordance with one embodiment of the present disclosure. The electronic document 320 is shown with an upload dialog box 310. The upload dialog box indicates the progress of the upload. Here, the upload is eighty-five percent (85%) complete. This figure represents the percentage of the document's file size (in relation to its entire file size) that has uploaded into the system.

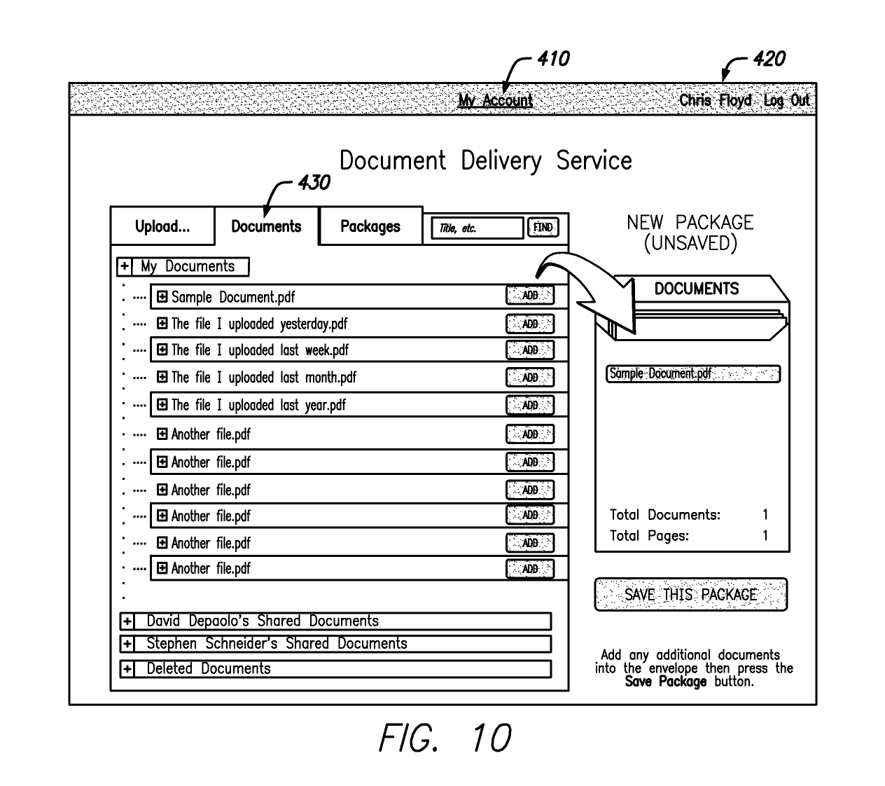

The user may manage and view uploads, documents and packages associated with the user's account by accessing the “My Account” section of the site. As part of this functionality, the user may enter documents into a package. Referring now to FIG. 10, illustrated is a screenshot that permits a user to enter documents into a package for the document delivery system in accordance with one embodiment of the present disclosure. At the uppermost part of the screen, the screenshot shows that the “My Account” section 410 of the site has been accessed by the user. The user's name can be seen at the user name section 420 of the screen. Here, the user is preparing to designate the document that was previously uploaded for delivery into a package. The user may add as many uploaded documents as the user would like into this package.

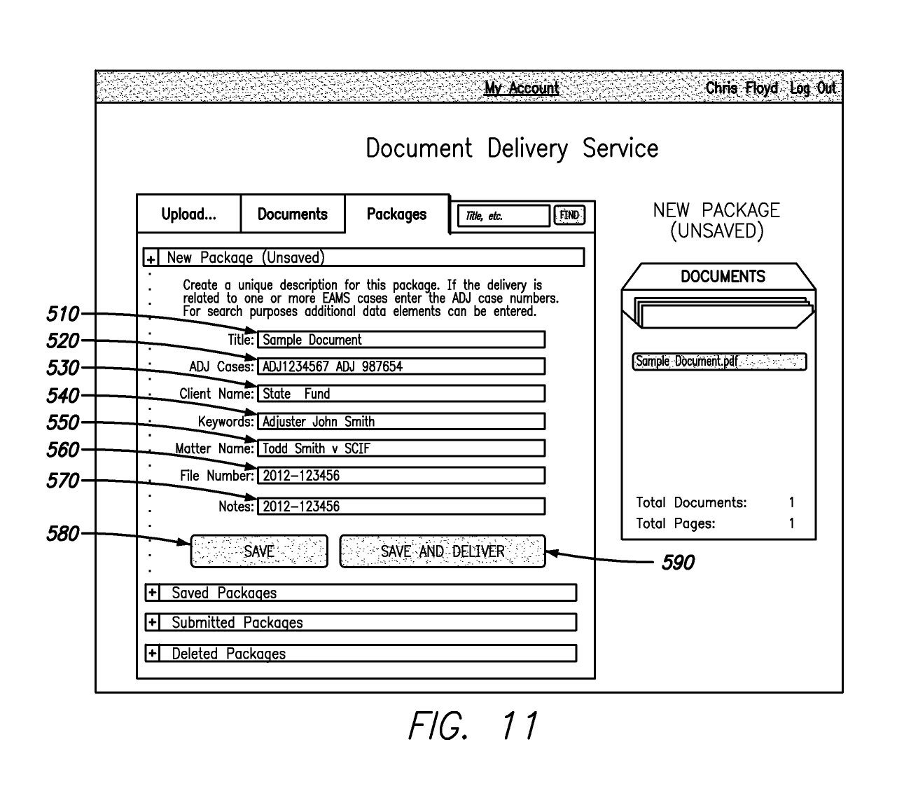

Referring now to FIG. 11, illustrated is a screenshot that permits a user to enter a unique description for a new package that is to be delivered with proof of service in accordance with one embodiment of the present disclosure. As shown, the user may enter a title for the package. Here, the title “Sample Package” has been entered at text box 510. The user may also enter a case number for the package as shown at text box 520 below the title field. A client name and keywords may also be associated with the package. Here, the client name is State Fund and the keywords are “Adjuster John Smith” as shown at text boxes 530 and 540. A matter name, file number and notes may be associated with the package. Here, the matter name is Todd Smith v. SCIF as shown at text box 550. The file number is 2012-123456 as shown at text box 560, and the notes are 2012-123456 as shown at text box 570. Then the package may be saved using the “save” button at 580. Alternatively, the package may be saved and delivered by selecting the appropriate button 590. From the “Packages” tab, the user may also view saved packages, submitted packages and deleted packages as shown by the expandable buttons located near the bottom of the screenshot.

It should be noted that the terms entered to describe the package are searchable. Thus, if a user wished to search for all files having Adjuster John Smith associated with them, the user would enter “Adjuster John Smith” in the field at the upper right portion of the screen.

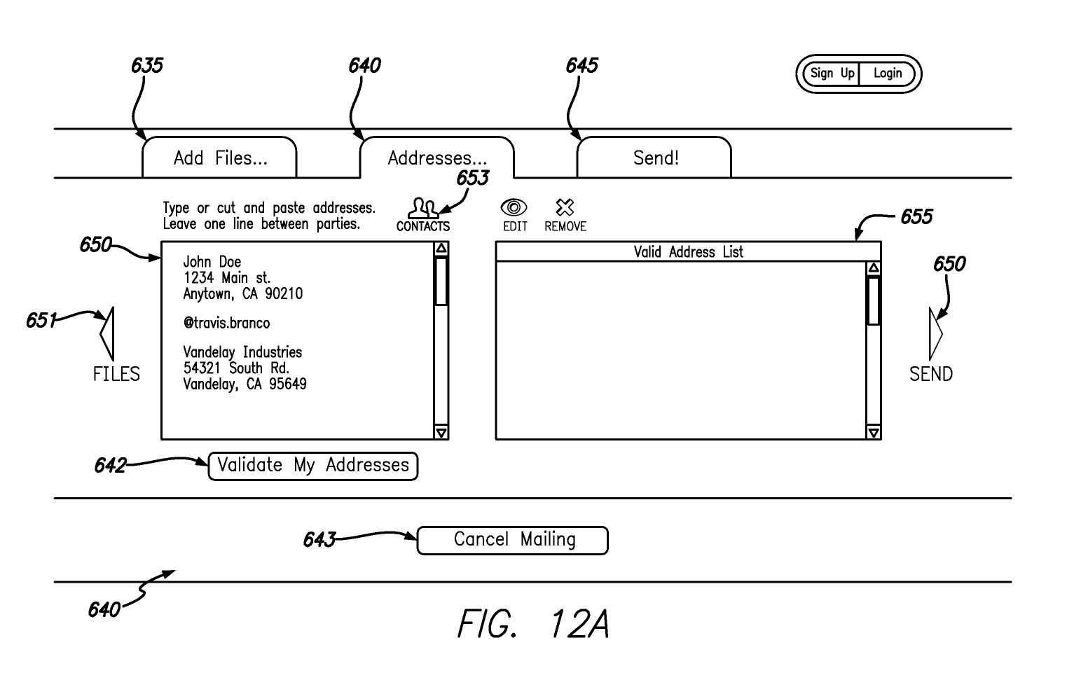

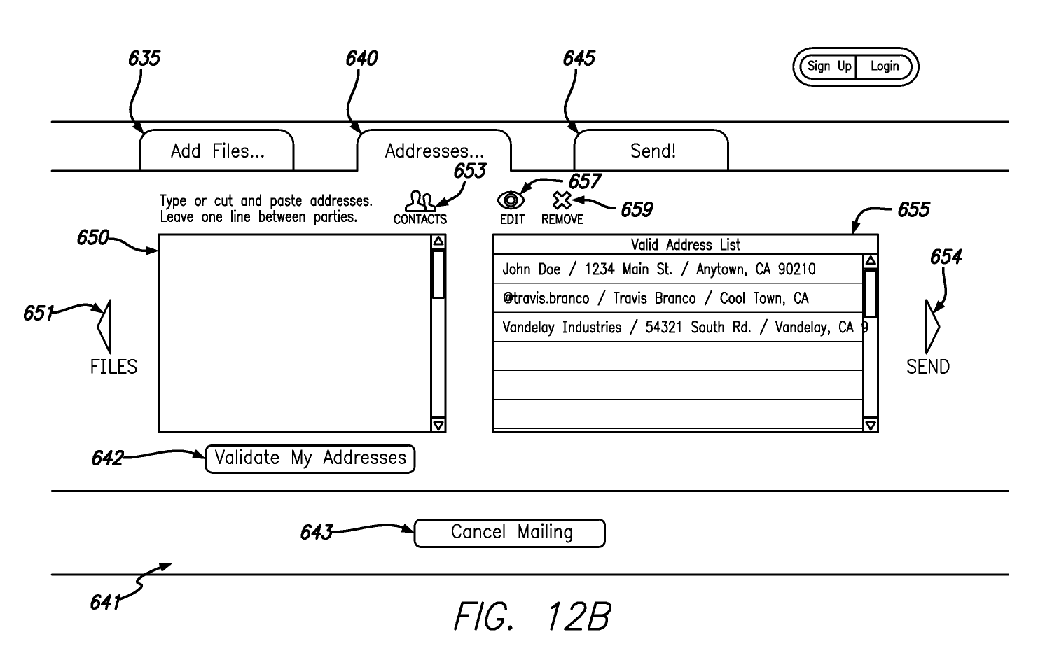

The user may use the web application programming interface (API) of the document delivery system in order to send documents. Referring now to FIG. 12A, illustrated is a screenshot that aids in the process of validating recipient addresses. Once the address has been validated, documents may be delivered in accordance with one embodiment of the present disclosure.

When a user prepares to send a message, a user screenshot, e.g., screenshot 640, may appear with three tabs 635, 640, 645. The tabs may include an add files tab 635, an addresses tab 640 and a send tab 645. The add files tab 635 may be used to add one or more uploaded electronic documents to a mailing as described hereinabove. In the present illustration, the sender-user has selected the addresses tab 640. The sender-user may have input the three addresses in the address validation box 650 in a number of ways. For example, the sender-user may have input these addresses by selecting them from his/her contacts list, or by typing the addresses manually, or by cutting and pasting one or more of the addresses into the address validation box 650. Here, the user has input the following three proposed recipients and addresses: (1) John Doe at 1234 Main St., Anytown, Calif. 90210; (2) @jane.smith; and (3) Vandelay Industries at 54321 South Rd., Vandelay, Calif. 95649. At any point, the user could select the files icon 651 and go back to the previous screen. The user could also select the send icon 654 in order to advance to the send screen. The user could also cancel the mailing by selecting the cancel mailing icon 643.

After the sender-user inputs the proposed addresses, the sender-user may select the validate my addressses icon 642. The system may then validate the addresses for delivery. Validation of the addresses may differ, depending on whether the address is electronic or physical. An electronic @address, e.g., the address to @jane.smith, may be considered valid when the intended recipient's account information includes an address that substantially matches the address that was input by the sender-user. A physical address may be considered validated when two conditions are met. First, the input physical address is compared to a physical address containing known address components. Second, the name associated with the input physical address is matched against known recipients associated with the known physical address components. If both these conditions are met, the physical address may be considered validated. If the addresses are not validated, one or more dialog boxes may appear, notifying the user that the addresses were not validated. In some cases, no match at all may be found. In other cases, a simple difference in the way a name is expressed may affect validation. For example, the address at 1234 Main St., Anytown, Calif. 90210 may have a known name associated with it, but the name may be expressed as J. Doe or Jonathan Doe. In this case, the system may notify the sender-user of the correct name associated with the address and ask if the sender-user would still like to send the documents.

Referring now to FIG. 12B, illustrated is a screenshot 641 that shows validated recipient delivery addresses in accordance with one embodiment of the present disclosure. Each of the delivery addresses that was previously input into the address validation box 650 is now shown in the validated addresses box 655. As shown in FIG. 12B, all of the three addresses that had been input into the address validation box 650 have been validated. The cities for the validated addresses are shown in the validated address box 655. In addition, the user may edit the addresses in the validated addresses box 655 by selecting the edit button 657. In the example given above where the sender-user entered the name John Doe, but the true name associated with the address is J. Doe or Jonathan Doe, the system may display a message notifying the user that there is a J. Doe or Jonathan Doe. The sender-user would then be given the option of correcting this name to J. Doe or Jonathan Doe, whichever is applicable by selecting edit button 657. The validation process may be comprised of several steps. For example, internal business logic may require that a blank line separate the names/addresses of each intended recipient. In addition, a tool that formats and/or matches the input physical addresses with known address components may be used. An example of such a tool is SMARTYSTREETS™. In addition, logic may be used for any other steps that are deemed appropriate in order to validate addresses within the system.

The user may also remove any validated addresses if the user decides not the send the document(s) to the validated address. The user may remove a potential recipient from the validated addresses box 655 by selecting the address that the user would like to remove from the mailing, and then selecting the remove button 659. In the present example, the user @Jane.Smith has been validated with a physical address in Cool Town, Calif. In response to a user request, e.g., user Jane Smith, the system may choose not to display any information regarding Jane Smith's physical location. For example, instead of showing Cool Town, Calif., the system could present only @Jane.Smith. The system could also choose not to offer this feature in response to a request. In this manner, when a sender-user is being charged for a mailing, the sender-user can confirm where the document(s) is/are being mailed. At any point, the user could select the files icon 651 and go back to the previous screen. The user could also cancel the mailing by selecting the cancel mailing icon 643.

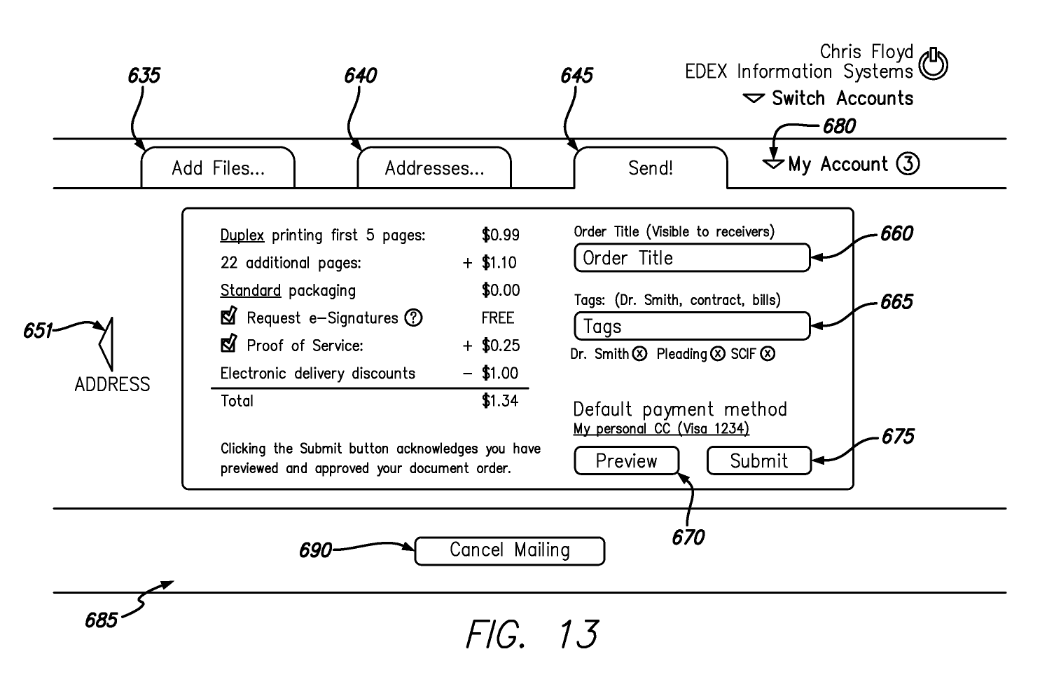

After the addresses have been validated, the user may send the document (s) to the validated addresses if so desired. The user may advance to the send screen by selecting either the send icon 654 or the send tab 655. Referring now to FIG. 13, illustrated is a send screenshot 685 through which the user may send documents for delivery over the document delivery system in accordance with one embodiment of the present disclosure.

As shown in the send screenshot 685 of FIG. 13, when the user selects the send tab 645, the user may be presented with a number of possible billing options for sending the electronic documents that were previously uploaded to the system to the electronic and/or physical endpoints. Examples of billing options are shown to the left of the screenshot 685. For example, the billing options may include the possible costs for duplex printing, requesting e-signatures and electronic delivery discounts or any other billing options or financial information deemed suitable.

As part of the billing options, the system may display where the mail is being delivered. For example, if a sender-user inputs a physical address but the recipient-user has an electronic delivery address, the system would validate the shipping address. However, when payment options were presented, the system would indicate that the user has an electronic delivery address, and that the sender-user need only pay for electronic delivery.

The user may also be presented with additional sending options to the right of the screen. Here, the user is presented with two additional options. The first option may be to give an order title to the mailing by entering the title in order title box 660. As indicated, this title may be visible to receivers/recipients. The order title may be a description that is useful to the sender or recipient in identifying the documents to be delivered. Components of the order title may be searchable by the sender-user by keywords or otherwise so that the sender-user can later easily retrieve this document.

The second option presented to the user may be to add a tag to the mailing by entering the tag into the tag box 665. Examples of tags that could be given are shown above tag box 665 and include, e.g., “Dr. Smith” and/or “contract” and/or “bills.” These are merely examples. Any tag deemed appropriate for the mailing may be entered by the sender-user here. Below the tag box 665 may be tags that were previously used by the sender. Here, the sender has previously used the tags Dr. Smith, pleading and SCIF. The system may be configured to not display these keywords to recipient-users. These tags may be searchable by the sender-user, e.g., when the sender-user inputs a hashtag # and the search term. Any other methods known in the art for searching tags may also be used. It should be noted that the system may be configured to retrieve only documents that the querying user has already received or sent. Here, the querying user is the sender-user. Accordingly, the system may be configured to retrieve only documents that were sent to, or received by, the querying user, and not documents related to other users where the sender is not a party to the document delivery. A box for inputting search terms may be provided on a sender-user's inbox or any other place deemed appropriate.

The system may also be configured to permit the recipient-user to input tags associated with each document delivery. These tags may be searchable, e.g., when the recipient querying user inputs a hashtag (#) and the search term. Any other methods known in the art for searching tags may also be used. It should be noted that the system may be configured only to retrieve documents that the recipient-user has already received or sent, and not documents related to other users where the sender is not a party to the document delivery. A box for inputting search terms may be provided on a receiver-user's inbox or any other place deemed appropriate.

A “my account” drop down menu icon 680 is shown at the upper right portion of the screen. By selecting this drop down menu icon 680, the user may view information associated with the user's account. For example, the drop down menu icon 680, when selected, could permit the user to see information about documents uploaded, documents received, documents sent, as well as packages sent and received. It could also show documents that are shared by the user and another party. Examples of this information are illustrated in connection with FIG. 10 hereinabove.

At the bottom of the screen, the default payment method is shown that has been entered by the user as part of the user account information. The user may use the credit card indicated by the title “Personal CC Visa 1234”. If the user would like to change the billing card, that option is available as well. The user may also select the preview button 670 in order to preview the message that will be sent. The system may be configured to permit the sender-user to preview the final merged PDF document delivery prior to the time that it is sent.

If the user now wishes to send the document(s), the user may select the submit button 675, at which point the message would be sent to the validated users on the recipient list. At any point, the user could select the “address” icon 661 and go back to the previous screen. The user could also press the cancel mailing icon 690 in order to cancel sending the documents to the identified endpoints previously selected.

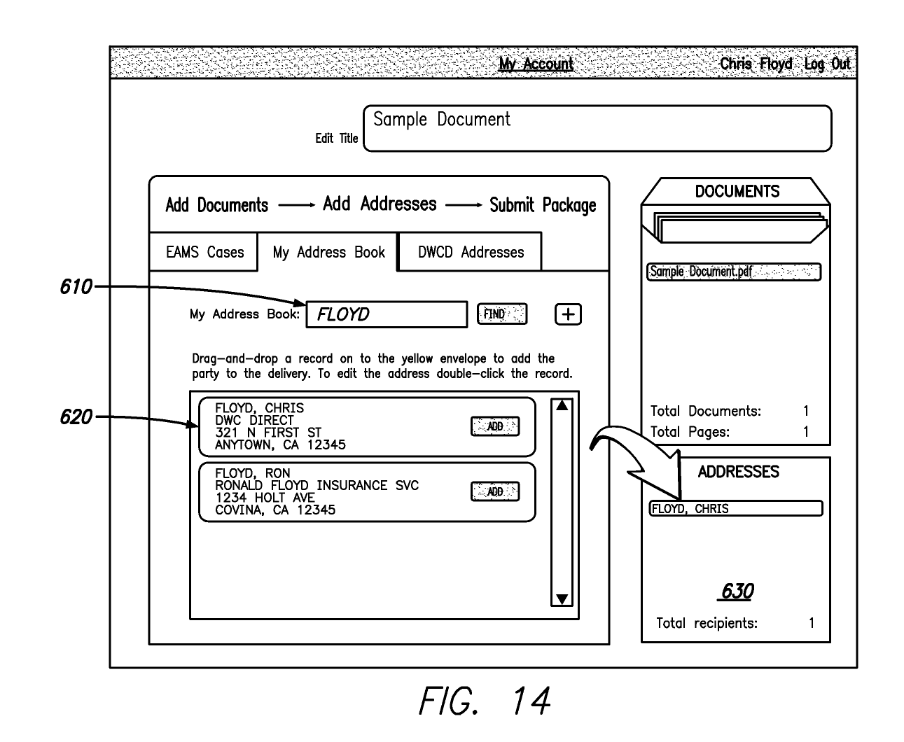

Referring now to FIG. 14, illustrated is another embodiment of a screenshot that permits a user to enter a recipient for the package and submit the package for delivery in accordance with one embodiment of the present disclosure. As shown near the top of the screen, the user may first add documents (performed in previous screenshot), then the user may add addresses. Finally, the sender submits the package. Here, the user is at the add address phase. The user selects the address(es) to which he/she would like the package delivered. Here, the addresses are separated by the user into three categories: (a) EAMS cases; (b) my address book; and (c) DWCD addresses. These categories represent the source for the address. The “My Address Book” source may represent a personal address book for the particular user. Here, the user has located the intended recipient by entering the search term Floyd in text box 610. The user then drags and drops the information for Chris Floyd from text box 620 into the envelope 630 at the right side of the screen.

Now, the user is preparing to submit the package. The system may be configured to validate, based on either a unique identification code for each received electronic document or a unique package identification number for a single multi-document package, that a multi-document package addressed to a physical endpoint includes all received electronic documents for a recipient at the physical endpoint.

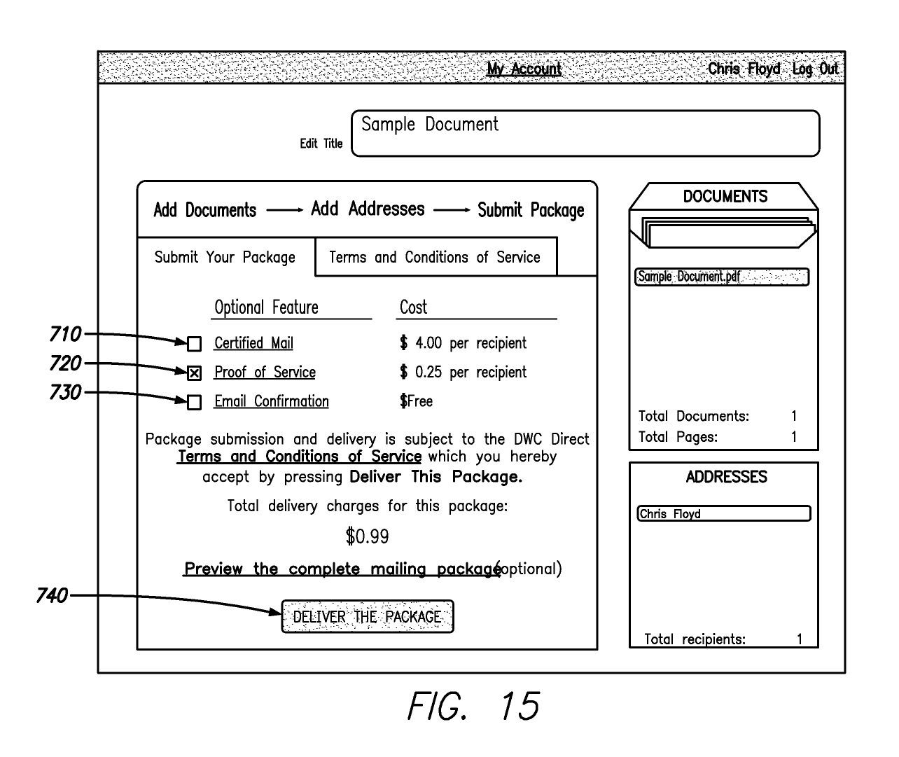

The user may also be permitted to select optional services for the package. Referring now to FIG. 15, illustrated is a screenshot that permits a user to select optional services for the package in accordance with one embodiment of the present disclosure. As shown in the screenshot, the user may choose the optional services of certified mail by selecting box 710, proof of service by selecting box 720, or email confirmation by selecting box 730. The cost for the particular service is shown to the right of the screenshot. As the user selects optional services, the total price for the selected services may be previewed. The user may also preview the complete mailing package, if desired. Finally, the user may select the “deliver package” icon at 740 in order to direct that the package be delivered. The terms and conditions of service may be viewed by selecting the appropriate tab near the top of the screen.

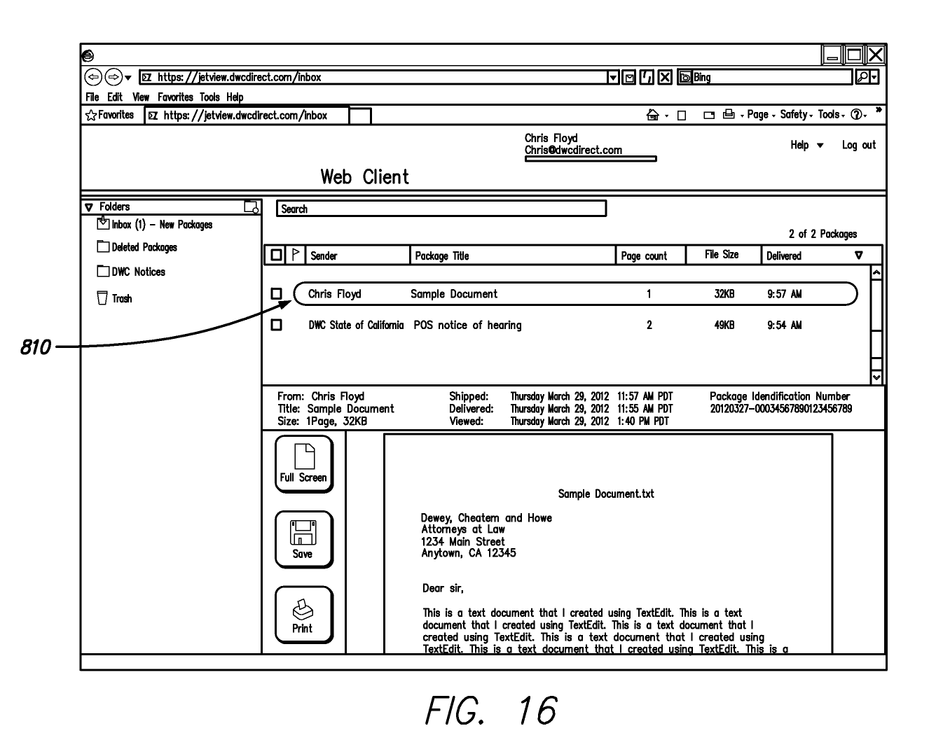

After the package has been delivered to a user who has agreed to accept electronic documents, the package may be viewed by the appropriate recipient when he/she logs into his/her account. Referring now to FIG. 16, illustrated is a screenshot at a recipient's computer after the recipient has opened the package subject to proof of service in accordance with one embodiment of the present disclosure. Here, the recipient has received a package from Chris Floyd as shown at line 810. The recipient can see that the title is “Sample Document” as also shown at line 810. The recipient can also see the page count, file size and time the package was delivered.

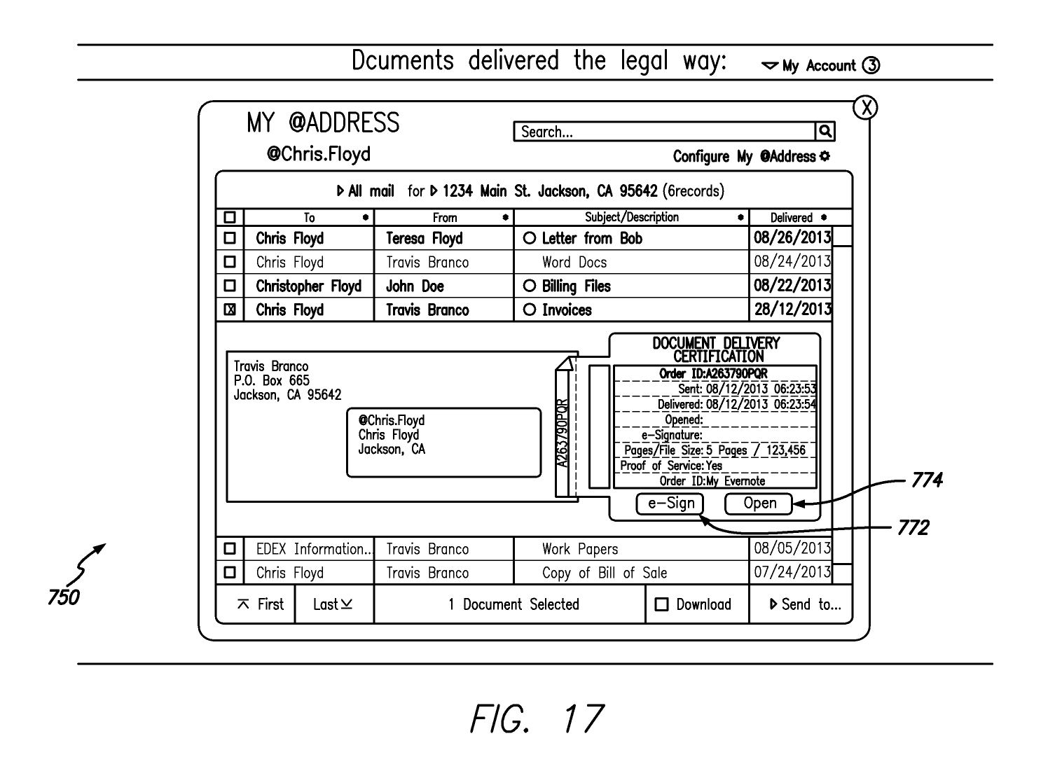

Referring now to FIG. 17, illustrated is a screenshot of a user inbox for the document delivery system in accordance with one embodiment of the present disclosure. This screenshot shows an inbox for user @Chris.Floyd. The inbox shows six (6) records for documents delivered to Chris Floyd. As illustrated in the present screenshot, all mail for 1234 Main St. Jackson, Calif. 95642 is shown. Apparently, Chris Floyd's physical mailing address is 1234 Main St. Jackson, Calif. 95642. However, he has chosen to have his mail delivered to his @address, @Chris.Floyd. Six (6) records of documents delivered are shown in the screenshot. The first piece of mail shown is a letter to Chris Floyd from Teresa Floyd with the description “Letter from Bob.” This first piece of mail was delivered on Aug. 26, 2013. The second piece of mail shown is to Chris Floyd from Travis Branco, and is titled “Word Docs.” Because this second piece of mail has already been opened, as indicated by the lack of bold text and lack of circle next to the subject/description for this second piece of mail. The third document delivery was from John Doe to Chris Floyd and is titled “Billing Files”. It was delivered on Aug. 22, 2013. The fourth document is from Travis Branco to Chris Floyd and is titled “Invoices.” It was delivered on Aug. 12, 2013. User Chris Floyd has selected this message in order to view details. Here, Chris Floyd sees that the item was delivered to @Chris.Floyd, an @address.

User Chris Floyd also sees a document delivery e-certification 760 generated by the document delivery system. The document delivery e-certification includes the order number A263790PQR. The e-certification 760 is for a document sent on Aug. 12, 2013 at 6:23:53, and delivered on Aug. 12, 2013 at 06:23:54. The e-certification may be performed automatically by the system, or any other method deemed suitable. In the present example, the e-certification 760 does not show that the document has been opened. Had the document been opened, the e-certification would have indicated that the document had been opened. The e-certification may include the ability for a sender to track a document after it was opened. Thus, the sender could audit activity pertaining to the document delivery. As noted, the system could track when a document was opened. It may be possible for the system to update the e-certification each time a new tracking feature had been accomplished.

The e-certification 760 shows that the document includes five (5) pages, and has a size of 123,456 bytes. The e-certification 760 also shows that a proof of service was requested for the document. The document in this instance was copied to cloud-based storage, in this case EVERNOTE™. Delivered documents may be copied to cloud-based storage in packets. The e-sign button 772 may be used to collect an e-signature for the document. In this case, Chris Floyd may e-sign for this fourth document delivery record shown by pressing the e-sign button and manually entering his signature. The open button 774 may be used to open the document that was e-certified. The fifth document shown on the screenshot 750 is to EDEX Information from Travis Branco. They are titled “Work Papers”, and the record is dated Aug. 5, 2013. The sixth and final record to Chris Floyd from Travis Branco is titled “Copy of Bill of Sale” and was delivered Jul. 24, 2013.

At the bottom of screenshot 750, on the last row, additional information regarding records navigation is shown. The navigation tools include an arrow to move the user to the very first record in the user's inbox. The navigation tools also include an arrow to move the user to the very last record in the user's inbox. In addition, the screenshot 750 shows that one record was selected. This selected record was described above as “Invoices,” and was sent from Travis Branco to Chris Floyd. Still on the bottom row, moving to the right of screenshot 750, a download button is shown that permits the user to download documents. Last, shown is a send to button, which permits the user to forward a selected document to another user.

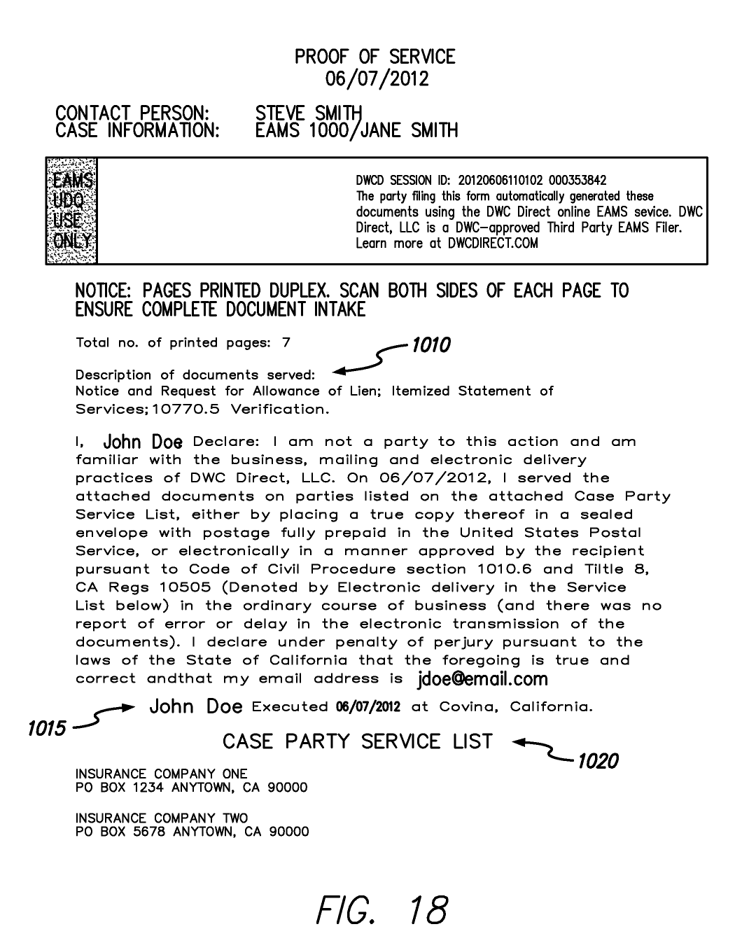

The sender had selected the proof of service option when submitting the package to the system. Therefore, the system may generate a proof of service after the system determines the delivery method as physical or electronic. The sender may receive a copy of this proof of service after it has been generated by the system. Referring now to FIG. 18, illustrated is an example of a proof of service generated by the system. Here, the proof of service is signed by John Doe. It shows the subject documents to be delivered are a Notice and Request for Allowance of Lien, an Itemized Statement of Services and a 10770.5 Verification as shown under line 1010 which reads “Description of Documents Served”. This proof of service shows the documents have been served on Insurance Company One and Insurance Company Two as shown at line 1020. The proof of service is signed by John Doe as shown at line 1015.

In addition to the proof of service, the sender may receive a receipt record showing that the document has been delivered to the recipient's account via the recipient's inbox, or that the document has been otherwise posted to the system for viewing by the intended recipient.

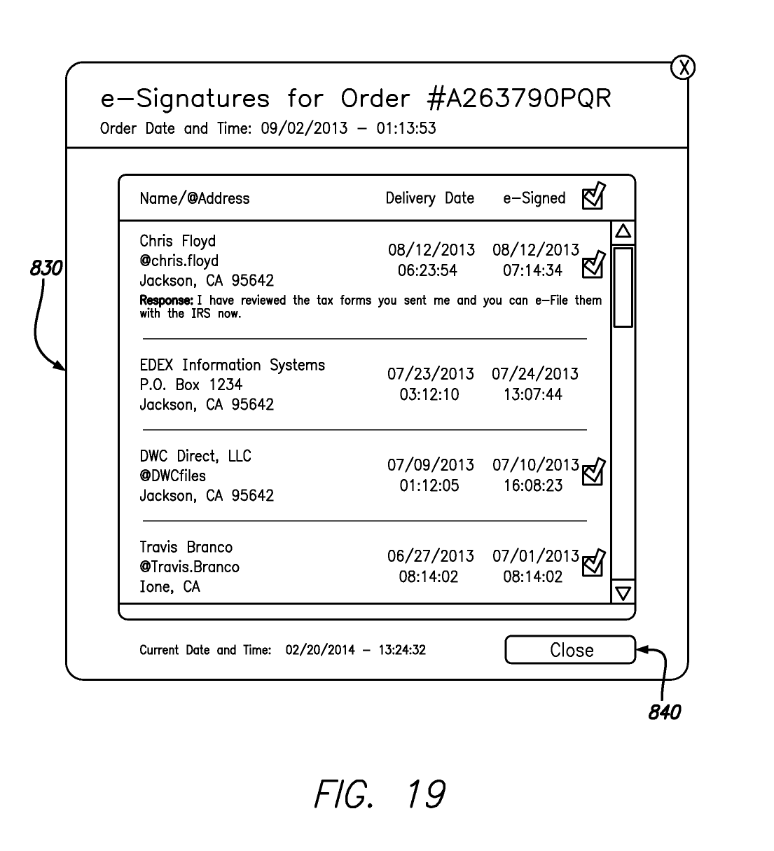

In addition, e-signatures may be generated for a particular document delivery. Referring now to FIG. 19, illustrated is a screenshot pertaining to e-signatures received in connection with the document delivery system in accordance with one embodiment of the present disclosure. As illustrated in the screenshot 830, e-signatures are shown for order #A263790PQR. This order was previously referenced in connection with FIG. 17 above. As shown in the leftmost column of FIG. 19, the name or @address is shown for each e-signature received in connection with the order. As shown in the middle column, the delivery date and time are shown. In the last and rightmost column, the date and time the document was e-signed is shown. At the bottom of the screen, the current date and time are shown. The user may close the e-signature screenshot 830 by selecting the close icon 840 or the “x” at the top right corner of screenshot 830. A note regarding an e-signature may be shown below the name or @address of the person giving the e-signature. Here, Chris Floyd notes as follows: “I have reviewed the tax forms you sent me and you can e-File them with the IRS now.”

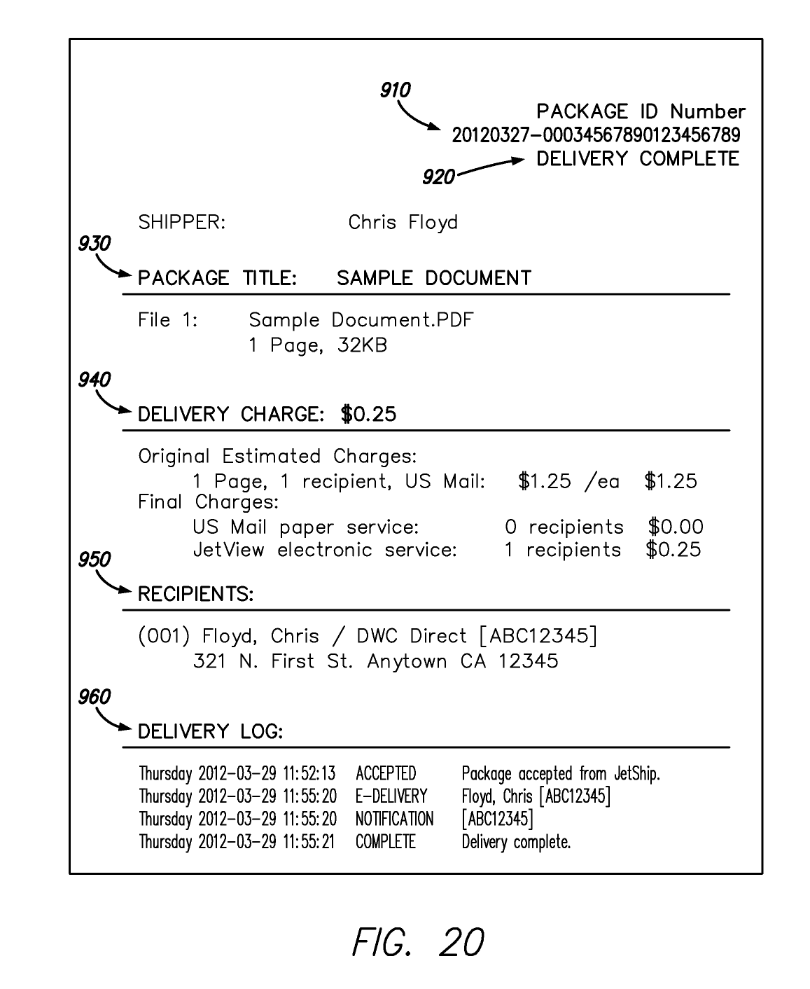

Referring now to FIG. 20, illustrated is a screenshot of a sender's receipt record for the package subject to proof of service in accordance with one embodiment of the present disclosure. This proof of service shows a unique package identification number at line 910 and that the package delivery is complete at line 920. The package title is also shown as “Sample Document” at line 930. The delivery charge is shown on the receipt at line 940. Also shown are the recipient at line and his address at line 950 and therebelow. Here, the recipient is Chris Floyd at DWC Direct whose address is 321 N. First St., Anytown, USA 12345. The delivery or audit log is shown at line 960 and below. It indicates the time that the package was accepted by the system for delivery. If the system is to carry out an electronic delivery the time stamps on the audit log showing electronic delivery and delivery completion may be very close to each other, e.g., within a second or two. In this example, delivery is carried out to a single electronic endpoint. However, if there were multiple endpoints in this example, and some were paper mail (not e-delivery), then the log may show different times for the e-delivery and the paper mail delivery times. The time differences could be in hours between the paper delivery end points and the e-delivery endpoints. In some cases, the time differences could be in days, since days might elapse between the time an electronic delivery occurs and a paper delivery occurs. For example, if a document was uploaded to the system on Friday, delivery to the paper endpoints might not begin until Monday, while the e-delivery endpoints would have received their documents on Friday.

The delivery log may show the date the system completed service of the subject document. In this example, the document in question was delivered electronically. Service may be considered complete when the document has been put into the recipient's electronic mailbox, or when the document has been otherwise posted to the system for viewing by the recipient. If the document is slated for physical delivery, service may be considered complete when the envelope has been deposited into a United States Postal Service mailbox or when the document was transferred or released to a carrier e.g., FEDERAL EXPRESS™ or a personal courier.

Using the document delivery system of the present disclosure, a sender/shipper may receive a legal proof of service on paper and electronic documents delivered to all recipients. Moreover, the aggregation of physical documents permits the sender/shipper to send the documents at an efficient price point. Where the documents are delivered electronically, the shipper may be able to reduce costs even further since no carrier or paper shipping costs would be applicable.

While the specification describes particular embodiments of the present invention, those of ordinary skill can devise variations of the present invention without departing from the inventive concept.

We claim:

1. A non-transitory computer-readable medium for document delivery to an electronic endpoint, the computer readable medium embodying a set of instructions which, when executed by one or more computer processors, comprises:
a document receipt code segment configured to receive electronic documents for delivery to one or more electronic endpoints, wherein the document receipt code segment is also configured to receive recipient data with each said received electronic document, said recipient data including at least one physical delivery endpoint or at least one username;
wherein said document receipt code segment further includes a tag input code segment, said tag input code segment being configured to receive input of one or more tags associated with at least one received electronic document;
an addressing code segment configured to retrieve, based on recipient data, an electronic endpoint associated with the recipient data that includes only the physical delivery endpoint, or based on recipient data that includes only the username;
a mail delivery code segment configured to deliver the received electronic document to an electronic endpoint based on recipient data that includes only the physical endpoint, said mail delivery code segment being further configured to deliver the received electronic document to an electronic endpoint based on recipient data that includes only the username;
a formatting code segment configured to format each physical delivery endpoint according to a formatting standard, the formatting code segment being further configured to substantially match address components for the received physical delivery endpoint to known address components;
a proof of service code segment configured to provide proof of service of each served electronic document if a proof of service request has been received; and
a receipt record code segment configured to generate and deliver a receipt record to a shipper, wherein the receipt record includes delivery data for the electronic document, including the time an electronic document was delivered to an electronic endpoint.

2. The computer-readable medium of claim 1, wherein the set of instructions further comprises:
an endpoint validation code segment configured to validate whether an input electronic endpoint substantially matches an electronic endpoint associated with any recipient data, said endpoint validation code segment being further configured to validate whether address components for the received physical delivery endpoint match known address components.

3. The computer-readable medium of claim 2, wherein:
the addressing code segment is further configured to receive a name associated with a physical delivery endpoint, and
the endpoint validation code segment is further configured to match the received name associated with a physical endpoint to a name associated with the known address components.

4. The computer-readable medium of claim 1, wherein the set of instructions further comprises:
a storage code segment configured to store the received electronic documents; and
a tag search code segment configured to retrieve received electronic documents sent to or from a querying user, if said received electronic documents have the same tag.

5. The computer-readable medium of claim 1, wherein the set of instructions further comprises:
a storage code segment configured to store the received electronic documents; and
an order title search code segment configured to retrieve, based on matching input, received electronic documents sent to or from a querying user, if said received electronic documents have the same input in their order title.

6. The computer-readable medium of claim 1, wherein the set of instructions further comprises:
an e-certification code segment configured to electronically transmit a certification of when the received electronic document was sent, when the received electronic document was delivered, whether the received electronic document was opened, whether the received electronic document contains an e-signature, the size of the received electronic document, whether a proof of service was made for the received electronic document and/or whether the received electronic document was copied to another storage location.

7. The computer-readable medium of claim 6, wherein the other storage location is cloud-based storage.

8. A non-transitory computer-readable medium for delivering documents to electronic and/or physical endpoints with multiple addressing and delivery options, the computer-readable medium embodying a set of instructions which, when executed by one or more computer processors, comprises:
a document receipt code segment configured to receive electronic documents for delivery to one or more physical and/or electronic endpoints, wherein the document receipt code segment is also configured to receive recipient data with each said received electronic document, said recipient data including at least one physical delivery endpoint or at least one username,
wherein said document receipt code segment further includes a tag input code segment, said tag input code segment being configured to receive input of one or more tags associated with at least one received electronic document, said tag input code segment being further configured to associate the tagged received electronic document with other received electronic documents that were sent to or from a querying user, if any, having the same tag;
an addressing code segment configured to retrieve, based on recipient data, at least one electronic and/or physical endpoint associated with the recipient data;
a mail delivery code segment configured to determine whether a received electronic document is to be delivered to a recipient via physical or electronic endpoint based on recipient data, the mail delivery code segment being further configured to deliver the received electronic document to an electronic endpoint based on recipient data that includes either only a physical endpoint or only a username;
a formatting code segment configured to format each received physical endpoint according to a formatting standard that permits aggregation of received electronic documents from multiple senders to a physical endpoint composed of known address components that substantially match address components for the received physical endpoint;
an aggregation code segment configured to facilitate the aggregation of physical documents into a single multi-document package from the multiple senders for delivery to the one or more endpoints, if the determined endpoint is physical, and wherein the aggregation code segment is further configured, based on unbundled delivery requirements associated with a particular endpoint of the one or more physical endpoints, not to aggregate physical documents for delivery in a package to the particular endpoint;
a proof of service code segment configured to provide proof of service of each served physical and/or electronic document if a proof of service request has been received;
a multi-document validation code segment configured to validate, based on either a unique identification code for each received electronic document or a unique package identification number for a single multi-document package, that a multi-document package addressed to a physical endpoint includes all received electronic documents for a recipient at the physical endpoint; and
a receipt record code segment configured to generate and deliver a receipt record to a shipper, wherein the receipt record includes delivery data for the physical and/or electronic document, including the time an electronic document was delivered to an electronic endpoint.

9. The computer readable-medium of claim 8, wherein the addressing code segment is configured to retrieve an electronic endpoint based recipient data that includes only the physical delivery endpoint, and wherein the addressing code segment is further configured to retrieve an electronic endpoint based on recipient data that includes only the username.

10. The computer-readable medium of claim 8, wherein the aggregation code segment is further configured, based on unbundled delivery requirements associated with a particular endpoint of the one or more physical endpoints, not to aggregate physical documents for delivery in a package to the particular endpoint.

11. The computer-readable medium of claim 8, wherein the set of instructions further comprises:
an endpoint validation code segment configured to validate whether an input electronic endpoint substantially matches an electronic endpoint associated with any recipient data, said endpoint validation code segment being further configured to validate whether address components for the received physical delivery endpoint match known address components.

12. The computer-readable medium of claim 8, wherein:
the addressing code segment is further configured to receive a name associated with a physical delivery endpoint, and
the endpoint validation code segment is further configured to match the received name associated with a physical endpoint to a name associated with the known address components.

13. The computer-readable medium of claim 8, wherein the set of instructions further comprises:
an email confirmation code segment configured to provide confirmation of delivery of electronic documents to the electronic endpoint or release of physical documents to the carrier.

14. The computer-readable medium of claim 8, wherein the set of instructions further comprises:
a certified mail code segment configured to certify that an electronic document was opened by the recipient and/or that a physical document was delivered by the carrier to the physical endpoint.

15. A computer-based method for delivering physical and electronic documents with multiple addressing and delivery options, comprising the steps of:
receiving, by a computer, a plurality of electronic documents, for delivery to one or more physical and/or electronic endpoints, wherein at least one of the plurality of received electronic documents includes recipient data indicating delivery to a physical endpoint, and at least one of the plurality of electronic documents includes recipient data indicating delivery to an electronic endpoint, said recipient data including at least one physical delivery endpoint or at least one username;
receiving, by the computer, one or more tags associated with at least one received electronic document;
retrieving, by the computer, based on recipient data, an electronic endpoint associated with the recipient data that includes only the physical delivery endpoint, or based on recipient data that includes only the username;
determining, by the computer, whether a received electronic document is to be delivered to a recipient via physical or electronic endpoint based on recipient data;
in response to the determining step, performing the following steps for each of the plurality of electronic documents:
if the determining step indicates delivery to an electronic endpoint, delivering, by the computer, the received electronic documents to electronic endpoints based on recipient data that includes only the physical endpoint;
if the determining step indicates delivery to an electronic endpoint, delivering, by the computer, one or more received electronic documents to electronic endpoints based on recipient data that includes only a username;
if a request for proof of service has been received, providing, by the computer, proof of service of each served physical and/or electronic document; and
generating, by the computer, and delivering, by the computer, an electronic receipt record to a shipper, wherein the receipt record includes delivery data for the served physical and/or electronic document, including the time the electronic document was delivered to the electronic endpoint and/or the time the physical document was released to a carrier for physical delivery.

16. The method claim 15, further comprising:
in response to the determining step:
if the determining step indicates delivery to a physical endpoint, formatting, by the computer, each received physical endpoint according to a formatting standard that permits aggregation of received electronic documents from multiple senders to a physical endpoint composed of known address components that substantially match address components for more than one received physical endpoint.

17. The method claim 15, further comprising:
in response to the determining step:
if the determining step indicates delivery to a physical endpoint, facilitating, by the computer, the aggregation of the physical documents into a single multi-document package for delivery to the one or more physical endpoints or, based on unbundled delivery requirements associated with a particular endpoint of the one or more endpoints, determining, by the computer, that aggregation will not occur for physical documents to the particular endpoint.

18. The method claim 15, further comprising:
in response to the determining step:
if the determining step indicates delivery to a physical endpoint, validating, by the computer, based on either a unique identification code for each received electronic document or a unique package identification number for the single multi-document package, that the document or multi-document package addressed to the physical and/or electronic endpoint includes all received electronic documents for a recipient at the physical and/or electronic endpoint.

19. The method of claim 15, further comprising:
electronically transmitting a certification of when the received electronic document was sent, when the received electronic document was delivered, whether the received electronic document was opened, whether the received electronic document contains an e-signature, the size of the received electronic document, whether a proof of service was made for the received electronic document and/or whether the received electronic document was copied to another storage location.

20. The method of claim 15, further comprising:
storing the received electronic documents; and
in response to a user query, retrieving received electronic documents sent to or from the querying user, if said received electronic documents have the same tag.

21. The method of claim 14, wherein the receiving step further includes receiving a request for proof of service of each received electronic document to the one or more physical and/or electronic endpoints, and the method further comprises:
providing, by the computer, proof of service of each served physical and/or electronic document if a proof of service request has been received.
